(19) United States
(12) Patent Application Publication
(10) Pub. No.: US 2016/0234668 A1
(43) Pub. Date: Aug. 11, 2016

(54) METHOD FOR PERFORMING FUNCTION AND DEVICE FOR PROVIDING THE SAME

(71) Applicant: Samsung Electronics Co., Ltd., Gyeonggi-do (KR)

(72) Inventor: Yohan LEE, Gyeonggi-do (KR)

(21) Appl. No.: 15/016,861

(22) Filed: Feb. 5, 2016

(30) Foreign Application Priority Data
Feb. 6, 2015 (KR) 10-2015-0018435

(51) Int. Cl. H04W 4/22; G08B 25/10; G08B 25/00; G06F 3/14; H04M 1/27

(52) U.S. Cl. CPC H04W 4/22; G06F 3/14; H04M 1/27; G08B 25/009; G08B 25/10

(57) ABSTRACT

An electronic device comprising: a memory; an input interface; at least one processor operatively coupled to the memory, configured to: receive a signal, via the input interface, that is generated in response to a physical deformation of an auxiliary device; detect whether the signal satisfies a predefined condition; and perform an operation associated with the predefined condition in response to the signal satisfying the predefined condition.

### CLAIM OF PRIORITY

This application claims the benefit under 35 U.S.C. §119(a) of a Korean patent application filed on Feb. 6, 2015 in the Korean Intellectual Property Office and assigned Serial number 10-2015-0018435, the entire disclosure of which is hereby incorporated by reference.

### BACKGROUND

1. Field of the Invention

The present disclosure relates to a method for performing a function and a device for providing the same, and more particularly to the performing of a predetermined function when an electronic device senses a signal that satisfies a specific condition caused by an auxiliary device.

2. Description of the Related Art

Recently, with the abrupt development of communication technology, functions of an electronic device, such as a portable terminal, have been gradually expanded, and in accompaniment with this, a portable terminal may provide an implementation function related to a predetermined function in response to a specific input in more various manners.

In relation to such a portable terminal function, a portable terminal recently provides an emergency call origination in accordance with an emergency situation related to a crime or health through sensing of a specific button of the portable terminal or a scream.

### SUMMARY

According to aspects of the disclosure, an electronic device is provided comprising: a memory; an input interface; at least one processor operatively coupled to the memory, configured to: receive a signal, via the input interface, that is generated in response to a physical deformation of an auxiliary device; detect whether the signal satisfies a predefined condition; and perform an operation associated with the predefined condition in response to the signal satisfying the predefined condition.

According to aspects of the disclosure, an auxiliary device is provided comprising: a connection portion coupled to an electronic device; and a first portion arranged to be deformed when external pressure is applied to the first portion and provide to the electronic device a signal that is generated in response to the first portion being deformed, wherein the signal is provided to the electronic device via the connection portion.

According to aspects of the disclosure, a method is provided for use in an electronic device, comprising: receiving, by the electronic device, a signal that is generated as a result of a physical deformation of an auxiliary device; detecting whether the signal satisfies a predefined condition; and performing, by the electronic device, an operation associated with the predefined condition in response to the signal satisfying the predefined condition.

According to aspects of the disclosure, a method for use in an auxiliary device is provided having a connection portion and a deformable portion, comprising: generating a signal in response to the deformable portion being deformed by external pressure that is applied to the deformable portion; and providing the signal to an electronic device via the connection portion.

According to aspects of the disclosure, a system is provided comprising: an auxiliary device including a connection portion and a deformable portion configured to be deformed when external pressure is applied to the deformable portion, and provide to the connection portion a signal indicating that the deformable portion is deformed; and an electronic device coupled to the connection portion of the auxiliary device, wherein the electronic device is configured to receive the signal, detect whether the signal satisfies a predefined condition, and perform an operation associated with the predefined condition in response to the signal satisfying the predefined condition.

### BRIEF DESCRIPTION OF THE DRAWINGS

FIG. 1 is a diagram of an example of a network environment, according to various embodiments of the present disclosure;

FIG. 2 is a block diagram of an example of an electronic device, according to various embodiments of the present disclosure;

FIG. 3 is a block diagram of an example of a program module, according to various embodiments of the present disclosure;

FIG. 4A is a diagram of an example of an electronic device and an auxiliary device, according to various embodiments of the present disclosure;

FIG. 4B is a diagram of an example of an electronic device and an auxiliary device, according to various embodiments of the present disclosure;

FIG. 5 is a diagram of an example of an electronic device and an auxiliary device, according to various embodiments of the present disclosure;

FIG. 6 is a diagram of an example of an electronic device and an auxiliary device, according to various embodiments of the present disclosure;

FIG. 7 is a diagram of an example of an electronic device and an auxiliary device including a deformable portion, according to various embodiments of the present disclosure;

FIG. 8 is a diagram of an example of an electronic device and an auxiliary device including a deformable portion, according to various embodiments of the present disclosure;

FIG. 9A is a diagram of an example of an electronic device and an auxiliary device, according to various embodiments of the present disclosure;

FIG. 9B is a diagram of an example of a circuit for detecting that an auxiliary device is deformed, according to various embodiments of the present disclosure;

FIG. 10 is a diagram of an example of an electronic device and a strap type auxiliary device, according to various embodiments of the present disclosure;

FIG. 11 is a diagram of an example of an electronic device and an auxiliary device including an element that performs a specific function, according to various embodiments of the present disclosure;

FIG. 12 is a diagram of an example of an electronic device and an auxiliary device including a magnetic element, according to various embodiments of the present disclosure;

FIG. 13 is a diagram of an example of an electronic device and an auxiliary device including a deformable portion, according to various embodiments of the present disclosure;

FIG. 14 is a diagram of an example of an electronic device and an auxiliary device including a deformable portion, according to various embodiments of the present disclosure;

FIG. 15 is a diagram of an example of an electronic device and an auxiliary device including a deformable portion, according to various embodiments of the present disclosure;

FIG. 16 is a diagram of an example of an electronic device including a deformable portion, according to various embodiments of the present disclosure;

FIG. 17 is a flowchart of an example of a process, according to various embodiments of the present disclosure; and

FIG. 18 is a flowchart of an example of a process, according to various embodiments of the present disclosure.

### DETAILED DESCRIPTION

Hereinafter, various embodiments of the present specification will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used in the present disclosure are only used to describe specific embodiments, and are not intended to limit the present disclosure. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

In this disclosure, an electronic device may be a device that involves a communication function. For example, an electronic device may be a smart phone, a tablet PC (Personal Computer), a mobile phone, a video phone, an e-book reader, a desktop PC, a laptop PC, a netbook computer, a PDA (Personal Digital Assistant), a PMP (Portable Multimedia Player), an MP3 player, a portable medical device, a digital camera, or a wearable device (e.g., an HMD (Head-Mounted Device) such as electronic glasses, electronic clothes, an electronic bracelet, an electronic necklace, an electronic accessory, electronic tattoo, smart mirror or a smart watch). According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to some embodiments, an electronic device may be a smart home appliance that involves a communication function. For example, an electronic device may be a TV, a DVD (Digital Video Disk) player, audio equipment, a refrigerator, an air conditioner, a vacuum cleaner, an oven, a microwave, a washing machine, an air cleaner, a set-top box, a home automation control panel, a security control panel, a TV box (e.g., Samsung HomeSync™, Apple TV™, Google TV™, etc.), a game console, an electronic dictionary, an electronic key, a camcorder, or an electronic picture frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, a Global Navigation Satellite System (GNSS), an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof.

The electronic device according to some embodiments of the present disclosure may be a flexible device. Further, the electronic device according to an embodiment of the present disclosure is not limited to the aforementioned devices, and may include a new electronic device according to the development of technology

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

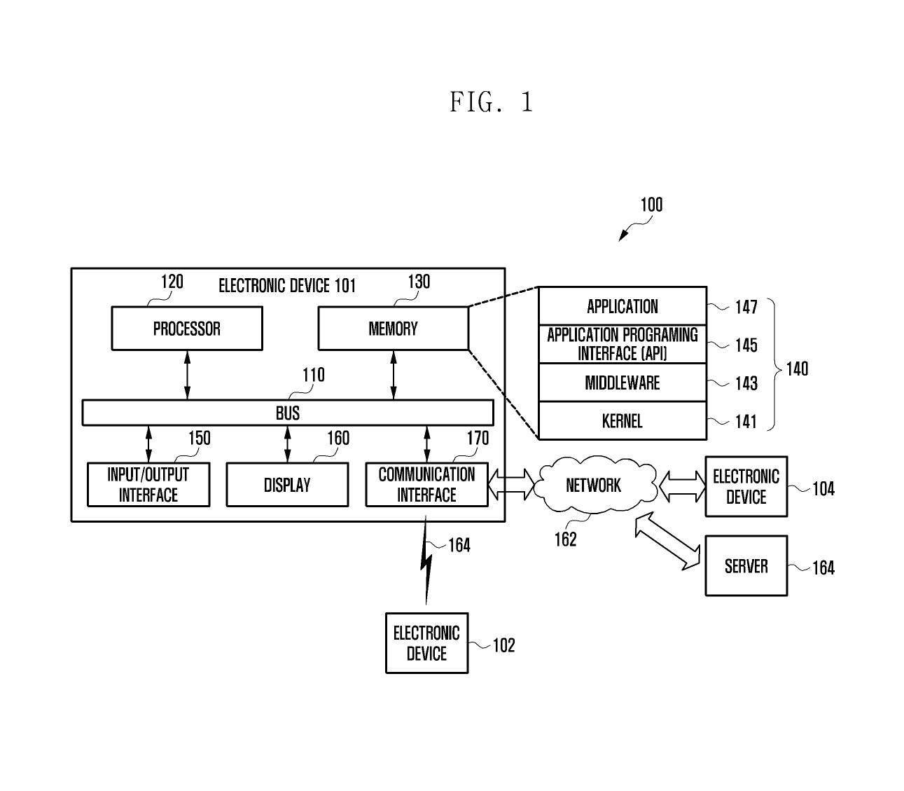

FIG. 1 is a block diagram illustrating a network environment 100 including therein an electronic device 101 in accordance with an embodiment of the present disclosure. Referring to FIG. 1, the electronic device 101 may include, but not limited to, a bus 110, a processor 120, a memory 130, an input/output interface 140, a display 150, a communication interface 160, and an application control module 170. In some embodiments, at least one of the elements of the electronic device 101 may be omitted or other elements may be additionally included in the electronic device 101.

The bus 110 may include, for example, a circuit which interconnects the elements 110 to 170 and delivers a communication (e.g., a control message and/or data) between the elements 110 to 170.

The processor 120 may include one or more of a Central Processing Unit (CPU), an Application Processor (AP), and a Communication Processor (CP). The processor 120, for example, may carry out operations or data processing relating to control and/or communication of at least one other element of the electronic device 101.

The processor 120 according to various embodiments of the present disclosure may support to perform an initialization process through control of power supply to respective constituent elements of the electronic device 101, and if the initialization process is completed, the processor 120 may control the respective constituent elements of the electronic device 101. The processor 120 may control the respective constituent elements of the electronic device 101 to perform the function according to various embodiments of the present disclosure.

In one embodiment, the processor 120 may receive an input that is caused by an auxiliary device 400 through the input/output interface 150. The processor 120 may control the respective constituent elements of the electronic device 101 to sense a signal that is included in the input or that is generated based on the input and to perform a predefined function if the sensed signal satisfies the predefined condition. In various embodiments, such a predefined function may be performed only once to correspond to the auxiliary device 400.

In an embodiment, the processor 120 may control the input/output interface 150 to establish an electrical connection with the auxiliary device 400. For example, the processor 120 may apply a voltage or current signal to the auxiliary device 400 through the input/output interface 150 or may sense a voltage or current signal that is generated in the auxiliary device 400. The electronic device 101 and the auxiliary device 400 may be connected to each other through a channel (e.g., wire) that includes at least one element (e.g., resistor, diode, or transistor). One end of such a channel may be connected to the input/output interface 150, and the other end thereof may be connected to the auxiliary device 400, but are not limited thereto. The input/output interface 150 according to various embodiments of the present disclosure may be connected to at least a partial region of the channel. Further, the channel may be extended to a deformable portion of the auxiliary device 400. In various embodiments, the auxiliary device 400 may be configured in a manner that a channel having no element is mounted on the deformable portion, and at least one element is mounted on one region excluding the deformable portion 400 of the auxiliary device 400.

In an embodiment, the processor 120 may supply a voltage or current signal to the auxiliary device 400 through the input/output interface 150. For example, the processor 120 may supply the voltage or current signal to the auxiliary device 400 through the input/output interface 150 and a channel connected to the input/output interface. In addition, the processor 120 may sense a voltage or current that is generated in a specific region (e.g., region having an NFC tag attached thereto, metal contact, chip, or coupling) of the electronic device 101 or the auxiliary device 400 through the input/output interface 150. For example, the deformable portion of the auxiliary device 400 may be deformed in accordance with external pressure to cause a channel open or deformation phenomenon, and the processor 120 may sense the voltage or current signal that is generated or changed in accordance with the deformed channel through the input/output interface 150. If the sensed electrical signal satisfies a predefined condition, the processor 120 may control the respective constituent elements of the electronic device 101 to perform a predefined function.

The processor 120 according to another embodiment may receive a voltage from the auxiliary device 400. For example, on one side of the auxiliary device 400, an element (e.g., piezoelectric element) that generates a voltage in response to an external pressure applied thereto may be mounted. The voltage that is generated when the external pressure is applied to the element may be transferred to the electronic device 101 through the channel connected to the element. The input/output interface 150 according to an embodiment may transfer information about the voltage or current that is received from the auxiliary device 400 to the processor 120 or the memory 130.

In some implementations, the input/output interface may include a magnetic sensor. In an embodiment, the processor 120 may control a magnetic sensor 240D to receive a magnetic signal from the auxiliary device 400. The processor 120 may control the respective constituent elements of the electronic device 101 to perform the predefined function if the received magnetic signal satisfies the predefined condition. For example, if a magnetic element that is mounted on one side of the auxiliary device 400 becomes adjacent to the magnetic sensor 240D of the electronic device 101 through the physical deformation of the auxiliary device 400 caused by the external pressure, the processor 120 may sense the generated magnetic signal through the magnetic sensor 240D and may perform a corresponding function.

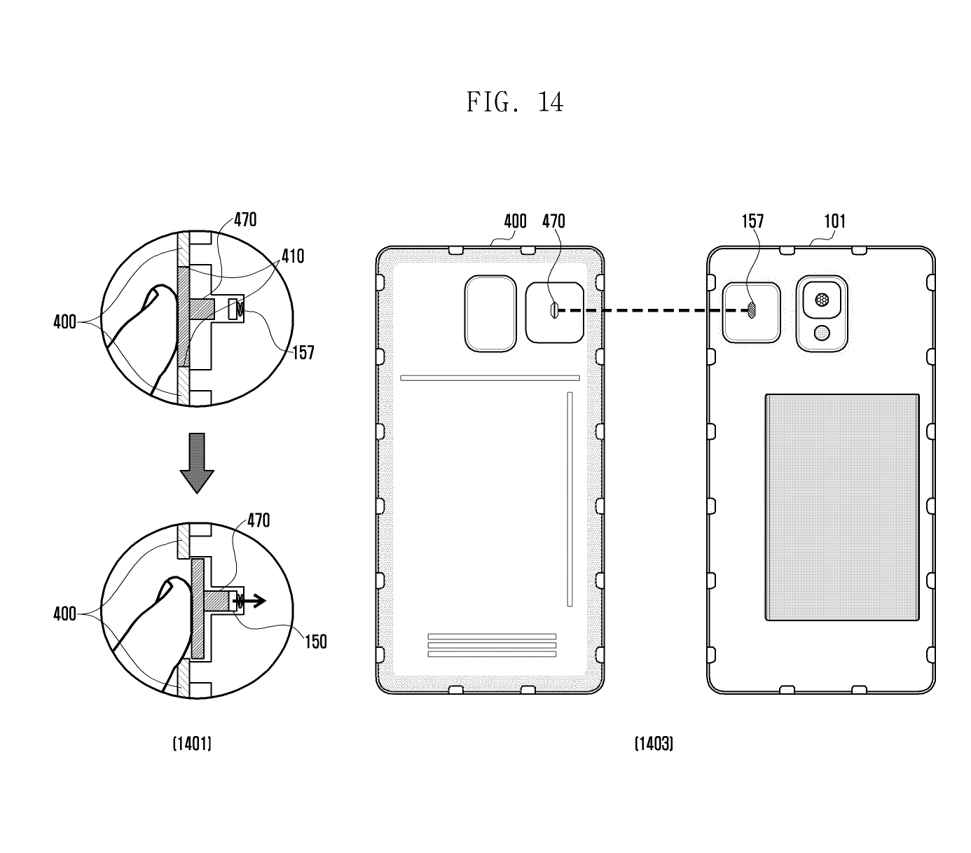

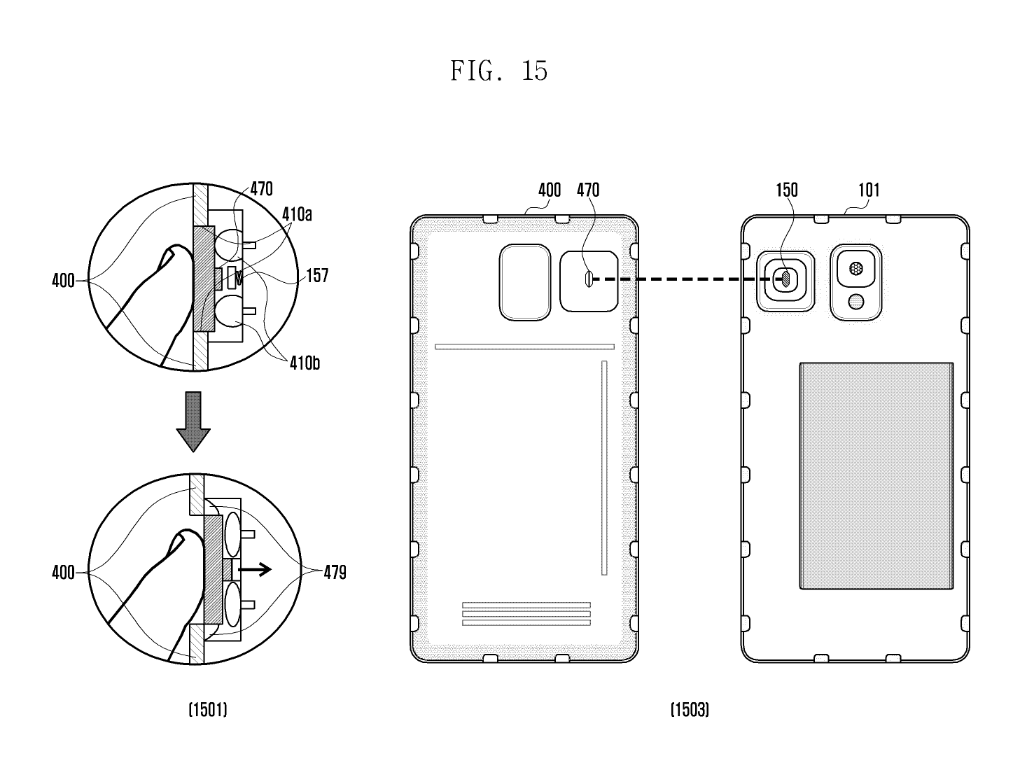

In an embodiment, the processor 120 may sense pressing (e.g., pressure input) of the input interface (button) of the electronic device 101 in accordance with the physical deformation of the at least partial region of the auxiliary device 400 (e.g., deformable portion of the auxiliary device), and may detect the signal that is generated in accordance with the pressure. If the generated signal satisfies the predefined condition, the processor 120 may control the respective constituent elements of the electronic device 101 to perform the predefined function. The detailed operation thereof will be described later with reference to FIGS. 14 and 15.

In an embodiment, the processor 120 may perform communication with at least one channel or at least one device as a predefined function. For example, the processor 120 transmits and receives information through communication with at least one channel or at least one device. For example, if the signal that is caused by the auxiliary device 400 satisfies the predefined condition, the processor 120 may control the communication interface 170 to perform communication with the at least one channel or at least one device. Through this, the processor 120 may control the communication interface 170 to request a call connection from a device that corresponds to a predefined phone number or to transmit/receive information through a predefined communication channel. For example, the processor 120 may transmit/receive a call connection or information that is related to an emergency mode to/from a predefined communication channel or device.

In an embodiment, the processor 120 may control the display 160 to display a graphic user interface on at least a partial region of the display 160 as a predefined function. For example, if the signal that is caused by the auxiliary device 400 satisfies a predefined condition, the processor 120 may control the display 160 to display the graphic user interface on one region of the display 160. In this case, the auxiliary device 400 can be detachably attached to the electronic device 101, but is not limited thereto. The auxiliary device 400 may be configured to be included in the electronic device 101 as one region. In another embodiment, in the case where the auxiliary device 400 is connected to the display 160 so as to cover at least a partial region of the display 160, and the sensed signal satisfies the predefined condition, the processor 120 may control the display 160 to display a predefined graphic user interface on a region of the display 160 that is exposed to an outside.

If the input received from the auxiliary device 400 or the signal generated by the received input satisfies the predefined condition, the processor 120 according to an embodiment of the present disclosure may confirm a region of the display 160 in which the auxiliary device 400 is not located within a predetermined threshold distance value from the display 160. For example, the processor 120 may determine the location or the shape of the auxiliary device 400 that covers one side of the display using a touch screen panel, a proximity sensor, an infrared sensor, or a hall sensor that is mounted on one side of the electronic device 101. This determination operation is exemplary, and various embodiments of the present disclosure are not limited thereto. For example, the processor 120 may determine a region of the display that is exposed to an outside in accordance with the defined physical deformation of the auxiliary device 400 based on inherent chip identification information ID included in the auxiliary device 400. Specifically, the processor 120 may collect inherent chip identification information ID or attribute information included in the auxiliary device and may compare the collected information with pre-stored information. The processor 120 may confirm the region of the display 160 that is exposed to the outside in accordance with the defined physical deformation of the auxiliary device 400 based on the compared information. In this case, the pre-stored information for the comparison may be received from another electronic device 102 or 104 or a server 106 through a network. In various embodiments, the processor 120 may confirm the region of the display 160 that is exposed to the outside in accordance with the defined physical deformation of the auxiliary device 400 on the basis of the identification information ID collected from the auxiliary device 400, and may output the corresponding user interface UI to the exposed region of the display 160 in accordance with the execution of the predefined function.

The processor 120 according to an embodiment of the present disclosure may control the display 160 to display a predefined graphic user interface in the confirmed region of the display 160. For example, the processor 120 may control the display 160 to display a graphic user interface for notifying of a warning message or an image item that can request call performance from a pre-stored phone number on the confirmed region of the display 160.

In another embodiment, the processor 120 may control an audio module 280 to perform audio output as a predefined function. For example, if at least one signal value that is received satisfies a pre-stored threshold value, the processor 120 may control a speaker 282 of the audio module 280 to output sound of a predetermined level (e.g., 60 dB or 70 dB).

The processor 120 according to an embodiment of the present disclosure may receive any one of an electrical signal and a magnetic signal. If the received signal value satisfies a predefined condition (e.g., pre-stored threshold value), the processor 120 may perform a predefined function.

The predefined condition according to an embodiment may be a comparison condition of voltage or current values. For example, the processor 120 may compare at least one received voltage or current value of a voltage or current value pre-stored in the memory 130. For example, if the received voltage value is 0.2 V and the pre-stored threshold voltage value is 0.2 V (error range of 5% or 10%), the processor 120 may perform a function that corresponds to the threshold voltage value. For example, if the function that corresponds to the threshold voltage value is a function of requesting a call connection to a pre-stored phone number, the processor 120 may perform call connection to the pre-stored phone number (e.g., 119, 911, or 112) through control of the communication interface 170.

The predefined condition according to an embodiment may be a comparison condition of magnetic values. For example, the processor 120 may compare a received magnetic signal value with the magnetic signal value stored in the memory 130. For example, if the received magnetic signal value is 0.1 A/m and the pre-stored threshold magnetic value is 0.09 A/m (error range of 5% or 10%), the processor 120 can perform a function corresponding to the threshold magnetic value. For example, if the function that corresponds to the threshold magnetic value is a function of requesting the call connection to the pre-stored phone number, the processor 120 may control the communication interface 170 to perform the call connection to the pre-stored phone number (e.g., acquaintance phone number or family phone number).

The memory 130 may include a volatile memory and/or a non-volatile memory. The memory 130 may store, for example, instructions or data relevant to at least one other element of the electronic device 101. According to an embodiment of the present disclosure, the memory 130 may store software and/or a program 140. The program 140 may include, for example, a kernel 141, middleware 143, an Application Programming Interface (API) 145, and/or application programs (or “applications”) 147. At least some of the kernel 141, the middleware 143, and the API 145 may be referred to as an Operating System (OS).

The memory 130 according to various embodiments of the present disclosure may store functions corresponding to pre-stored voltage or current values and functions corresponding to pre-stored magnetic values in tables. The memory 130 according to an embodiment may store data related to performing of a call request to a pre-stored phone number if the voltage is 0.2 V and performing of sound output over a threshold level if the current is 0.43 A/m, but is not limited thereto. The memory 130 may store various pieces of data that are required to perform predefined conditions or functions according to various embodiments of the present disclosure.

The kernel 141 may control or manage system resources (for example, the bus 110, the processor 120, or the memory 130) used for executing an operation or function implemented by other programs (for example, the middleware 143, the API 145, or the application 147). Furthermore, the kernel 141 may provide an interface through which the middleware 143, the API 145, or the application programs 147 may access the individual elements of the electronic device 101 to control or manage the system resources.

The middleware 143 may perform intermediation by which the API 145 or the application 147 communicates with the kernel 141 to transmit or receive data.

In addition, the middleware 143 may process one or more task requests received from the application programs 147 according to priorities thereof. For example, the middleware 143 may assign a priority, which enables the use of system resources (e.g., the bus 110, the processor 120, the memory 130, etc.) of the electronic device 101, to at least one of the application programs 147. For example, the middleware 143 may perform scheduling or loading balancing on the one or more task requests by processing the one or more task requests according to the priorities assigned thereto.

The API 145 which is an interface for allowing the application 147 to control a function provided by the kernel 141 or the middleware 143 may include, for example, at least one interface or function (e.g., a command) for a file control, a window control, an image processing, a text control, and the like.

The input/output interface 150, for example, may function as an interface that may transfer instructions or data input from a user or another external device to the other element(s) of the electronic device 101. Furthermore, the input/output interface 150 may output the instructions or data received from the other element(s) of the electronic device 101 to the user or another external device.

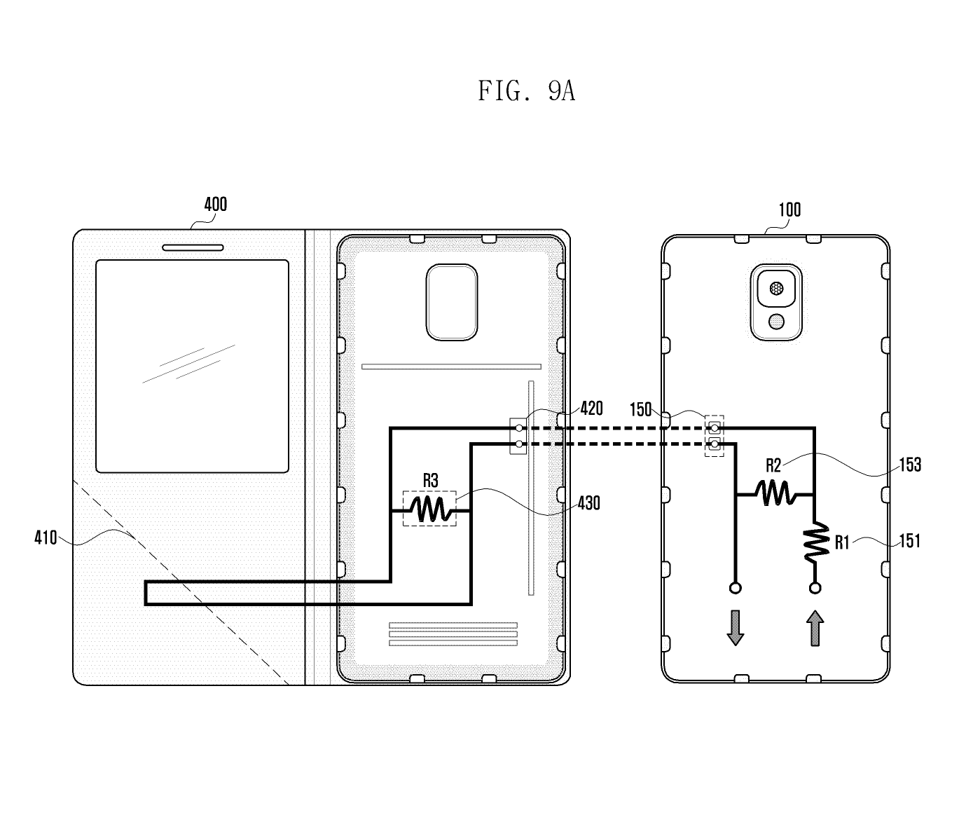

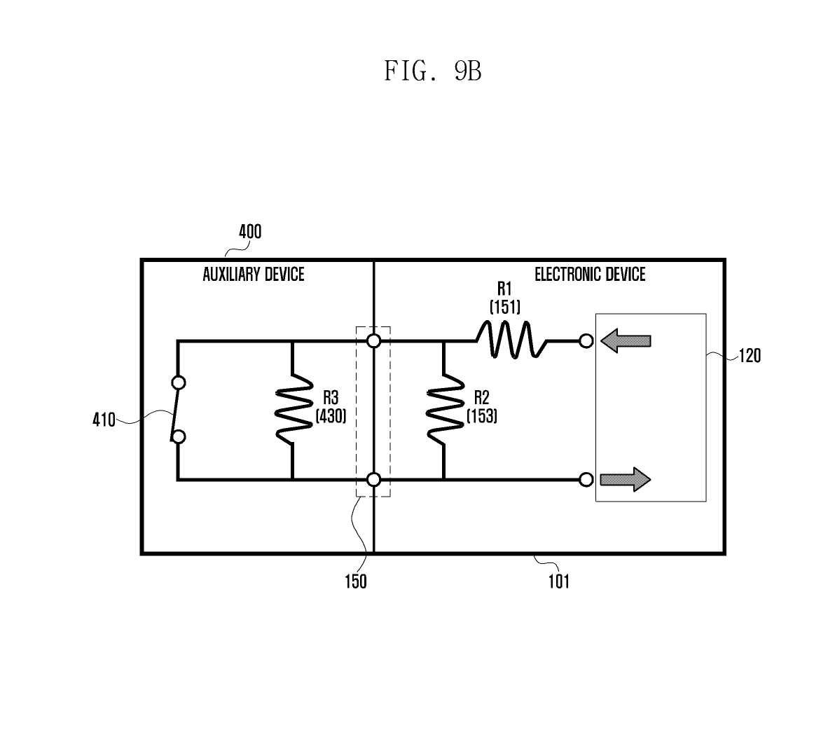

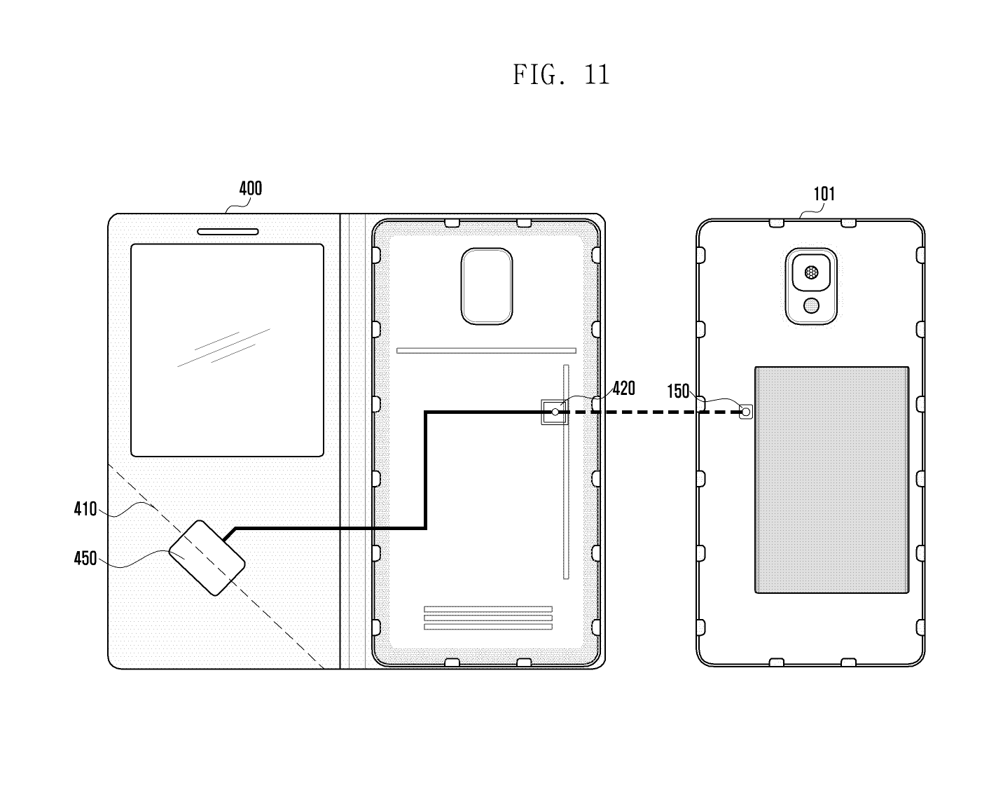

The input/output interface 150 according to various embodiments of the present disclosure may be implemented to include channels (wires) as indicated in FIGS. 9A, 9B, and 11 hereinafter. Further, the channel may be implemented by one circuit module included in the input/output interface 150. Through such channels, the input/output interface 150 may receive an input in accordance with physical deformation (e.g., opening) that occurs in the deformable portion of the auxiliary device 400 from the auxiliary device 400.

In an embodiment of the present disclosure, the input/output interface 150 may be connected to the auxiliary device 400, and may generate an electrical signal in accordance with an input that is received through the auxiliary device 400.

In various embodiments, the input/output interface 150 may be implemented to be physically mounted on one side of the electronic device 101. Accordingly, the input/output interface 150 may be moved or deformed by external physical pressure to generate an electrical signal for requesting a predefined function. This electrical signal may be sensed by the processor 120.

The display 160 may include, for example, a Liquid Crystal Display (LCD), a Light Emitting Diode (LED) display, an Organic Light Emitting Diode (OLED) display, a Micro Electro Mechanical System (MEMS) display, or an electronic paper display. For example, the display 160 may display various pieces of content (e.g., text, images, videos, icons, symbols, etc.) to the user. The display 160 may include a touch screen, and for example, receive a touch, gesture, proximity, or hovering input using an electronic pen or a body part of a user.

In various embodiments, the display 160 may display a screen according to various embodiments of the present disclosure, for example, a graphic user interface, such as an emergency mode. The graphic user interface may be displayed on at least a partial region of the display 160.

The communication interface 170, for example, may set communication between the electronic device 101 and an external device (e.g., the first external electronic device 102, the second external electronic device 104, or a server 106). For example, the communication interface 170 may be connected to a network 162 through wireless or wired communication to communicate with the external device (e.g., the second external electronic device 104 or the server 106).

In various embodiments, if the sensed signal satisfies the predefined condition, the communication interface 170 may request a call connection to a device that corresponds to a predefined phone number or may transmit information to a predefined communication channel.

The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), and Global System for Mobile Communications (GSM), as a cellular communication protocol. In addition, the wireless communication may include, for example, short range communication 164. The short-range communication 164 may include at least one of, for example, WiFi, Bluetooth, Near Field Communication (NFC), and Global Navigation Satellite System(GNSS).

The GNSS may include, for example, at least one of Global Positioning System (GPS), Global Navigation Satellite System (Glonass), Beidou Navigation Satellite System (hereinafter referred to as “Beidou”), and Galileo, the European global satellite-based navigation system. Hereinafter, in the description of the present disclosure, the term “GPS” may be interchangeably used with the “GNSS”.

The wired communication may include at least one of, for example, a Universal Serial Bus (USB), a High Definition Multimedia Interface (HDMI), Recommended Standard 232 (RS-232), and a Plain Old Telephone Service (POTS). The network 162 may include at least one of communication networks, such as a computer network (e.g., a Local Area Network (LAN), or a Wide Area Network (WAN)), the Internet, and a telephone network.

Each of the first and second external electronic devices 102 and 104 may be of a type identical to or different from that of the electronic device 101. According to an embodiment, the server 106 may include a group of one or more servers. According to various embodiments, all or some of the operations performed in the electronic device 101 may be performed in another electronic device or a plurality of electronic devices (e.g., the electronic devices 102 and 104 or the server 106). According to an embodiment, when the electronic device 101 has to perform some functions or services automatically or in response to a request, the electronic device 101 may make a request to perform at least some functions relating thereto to another device (e.g., the electronic device 102 or 104 or the server 106) instead of performing the functions or services by itself or additionally. The other electronic device (e.g., the electronic device 102 or 104 or the server 106) may carry out the requested functions or the additional functions and transfer the result to the electronic device 101. The electronic device 101 may process the received result as it is or additionally to provide the requested functions or services. To achieve this, for example, cloud computing, distributed computing, or client-server computing technology may be used.

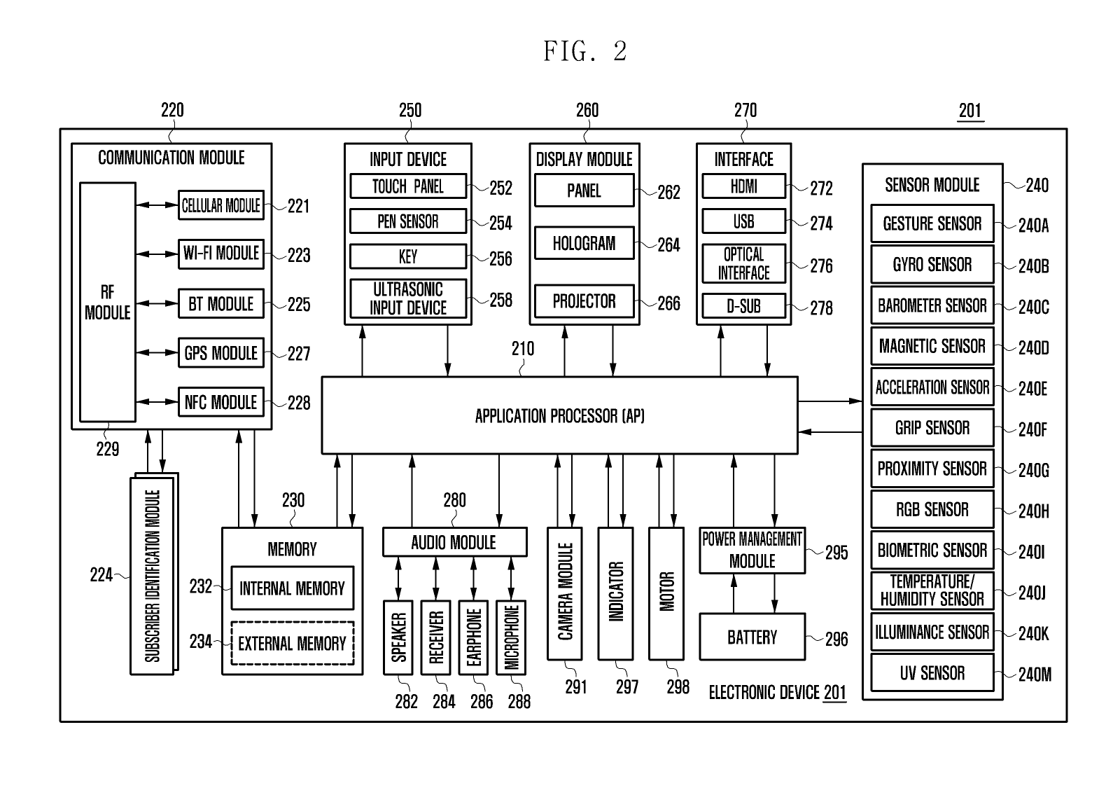

FIG. 2 is a block diagram illustrating an electronic device according to various exemplary embodiments. For example, the electronic device 201 may include the entirety or a part of the electronic device 101 illustrated in FIG. 1. The electronic device 201 may include at least one Application Processor (AP) 210, a communication module 220, a Subscriber Identification Module (SIM) card 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program and perform processing of various pieces of data and calculations. The processor 210 may be implemented by, for example, a System on Chip (SoC). According to an embodiment, the processor 210 may further include a Graphic Processing Unit (GPU) and/or an image signal processor. The processor 210 may include at least some (e.g., a cellular module 221) of the elements illustrated in FIG. 2. The processor 210 may load, into a volatile memory, instructions or data received from at least one (e.g., a non-volatile memory) of the other elements and may process the loaded instructions or data, and may store various data in a non-volatile memory.

The communication module 220 may have the same/similar configuration as/to the configuration of the communication interface 170 of FIG. 1. The communication module 220 may include, for example, a cellular module 221, a WiFi module 223, a Bluetooth module 225, a GNSS module 227 (e.g., a GPS module, a Glonass module, a Beidou module, or a Galileo module), an NFC module 228, and a Radio Frequency (RF) module 229.

The cellular module 221 may offer a voice call, a video call, a message service, an internet service, or the like through a communication network. Additionally, the cellular module 221 may perform identification and authentication of the electronic device in the communication network, using the SIM card 224. According to an embodiment, the cellular module 221 may perform at least part of functions the AP 210 can provide. According to an embodiment, the cellular module 221 may include a communication processor (CP).

Each of the WiFi module 223, the BT module 225, the GNSS module 227 and the NFC module 228 may include a processor for processing data transmitted or received therethrough. Although FIG. 2 shows the cellular module 221, the WiFi module 223, the BT module 225, the GNSS module 227 and the NFC module 228 as different blocks, at least part of them may be contained in a single IC (Integrated Circuit) chip or a single IC package in an embodiment.

The RF module 229 may transmit and receive data, e.g., RF signals or any other electric signals. Although not shown, the RF module 229 may include a transceiver, a PAM (Power Amp Module), a frequency filter, an LNA (Low Noise Amplifier), an antenna or the like. Although FIG. 2 shows that the cellular module 221, the WiFi module 223, the BT module 225, the GNSS module 227 and the NFC module 228 share the RF module 229, at least one of them may perform transmission and reception of RF signals through a separate RF module in an embodiment.

The SIM card 224 may be a specific card formed of SIM and may be inserted into a slot formed at a certain place of the electronic device. The SIM card 224 may contain therein an ICCID (Integrated Circuit Card IDentifier) or an IMSI (International Mobile Subscriber Identity).

The memory 230 (e.g., the memory 130) may include an internal memory 232 and an external memory 234. The internal memory 232 may include, for example, at least one of a volatile memory (e.g., DRAM (Dynamic RAM), SRAM (Static RAM), SDRAM (Synchronous DRAM), etc.) or a nonvolatile memory (e.g., OTPROM (One Time Programmable ROM), PROM (Programmable ROM), EPROM (Erasable and Programmable ROM), EEPROM (Electrically Erasable and Programmable ROM), mask ROM, flash ROM, NAND flash memory, NOR flash memory, etc.).

According to an embodiment, the internal memory 232 may have the form of an SSD (Solid State Drive). The external memory 234 may include a flash drive, e.g., CF (Compact Flash), SD (Secure Digital), Micro-SD (Micro Secure Digital), Mini-SD (Mini Secure Digital), xD (eXtreme Digital), memory stick, or the like.

The external memory 234 may be functionally connected to the electronic device 200 through various interfaces. According to an embodiment, the electronic device 200 may further include a storage device or medium such as a hard drive.

The sensor module 240 may measure physical quantity or sense an operating status of the electronic device 200, and then convert measured or sensed information into electric signals. The sensor module 240 may include, for example, at least one of a gesture sensor 240A, a gyro sensor 240B, an atmospheric sensor 240C, a magnetic sensor 240D, an acceleration sensor 240E, a grip sensor 240F, a proximity sensor 240G, a color sensor 240H (e.g., RGB (Red, Green, Blue) sensor), a biometric sensor 2401, a temperature-humidity sensor 240J, an illumination sensor 240K, and a UV (ultraviolet) sensor 240M. Additionally or alternatively, the sensor module 240 may include, e.g., an E-nose sensor (not shown), an EMG (electromyography) sensor (not shown), an EEG (electroencephalogram) sensor (not shown), an ECG (electrocardiogram) sensor (not shown), an IR (infrared) sensor (not shown), an iris scan sensor (not shown), or a finger scan sensor (not shown). Also, the sensor module 240 may include a control circuit for controlling one or more sensors equipped therein.

The input unit 250 may include a touch panel 252, a digital pen sensor 254, a key 256, or an ultrasonic input unit 258. The touch panel 252 may recognize a touch input in a manner of capacitive type, resistive type, infrared type, or ultrasonic type. Also, the touch panel 252 may further include a control circuit. In case of a capacitive type, a physical contact or proximity may be recognized. The touch panel 252 may further include a tactile layer. In this case, the touch panel 252 may offer a tactile feedback to a user.

The digital pen sensor 254 may be formed in the same or similar manner as receiving a touch input or by using a separate recognition sheet. The key 256 may include, for example, a physical button, an optical key, or a keypad. The ultrasonic input unit 258 is a specific device capable of identifying data by sensing sound waves with a microphone 288 in the electronic device 200 through an input tool that generates ultrasonic signals, thus allowing wireless recognition. According to an embodiment, the electronic device 200 may receive a user input from any external device (e.g., a computer or a server) connected thereto through the communication module 220.

The display 260 (e.g., the display 160) may include a panel 262, a hologram 264, or a projector 266. The panel 262 may be, for example, LCD (Liquid Crystal Display), AM-OLED (Active Matrix Organic Light Emitting Diode), or the like. The panel 262 may have a flexible, transparent or wearable form. The panel 262 may be formed of a single module with the touch panel 252. The hologram 264 may show a stereoscopic image in the air using interference of light. The projector 266 may project an image onto a screen, which may be located at the inside or outside of the electronic device 200. According to an embodiment, the display 260 may further include a control circuit for controlling the panel 262, the hologram 264, and the projector 266.

The interface 270 may include, for example, an HDMI (High-Definition Multimedia Interface) 272, a USB (Universal Serial Bus) 274, an optical interface 276, or a D-sub (D-subminiature) 278. The interface 270 may be contained, for example, in the communication interface 160 shown in FIG. 1. Additionally or alternatively, the interface 270 may include, for example, an MHL (Mobile High-definition Link) interface, an SD (Secure Digital) card/MMC (Multi-Media Card) interface, or an IrDA (Infrared Data Association) interface.

The audio module 280 may perform a conversion between sounds and electric signals. At least part of the audio module 280 may be contained, for example, in the input/output interface 140 shown in FIG. 1. The audio module 280 may process sound information inputted or outputted through a speaker 282, a receiver 284, an earphone 286, or a microphone 288.

The camera module 291 is a device capable of obtaining still images and moving images. According to an embodiment, the camera module 291 may include at least one image sensor (e.g., a front sensor or a rear sensor), a lens (not shown), an ISP (Image Signal Processor, not shown), or a flash (e.g., LED or xenon lamp, not shown).

The power management module 295 may manage electric power of the electronic device 200. Although not shown, the power management module 295 may include, for example, a PMIC (Power Management Integrated Circuit), a charger IC, or a battery or fuel gauge.

The PMIC may be formed, for example, of an IC chip or SoC. Charging may be performed in a wired or wireless manner. The charger IC may charge a battery 296 and prevent overvoltage or overcurrent from a charger. According to an embodiment, the charger IC may have a charger IC used for at least one of wired and wireless charging types. A wireless charging type may include, for example, a magnetic resonance type, a magnetic induction type, or an electromagnetic type. Any additional circuit for a wireless charging may be further used such as a coil loop, a resonance circuit, or a rectifier.

The battery gauge may measure the residual amount of the battery 296 and a voltage, current or temperature in a charging process. The battery 296 may store or create electric power therein and supply electric power to the electronic device 200. The battery 296 may be, for example, a rechargeable battery or a solar battery.

The indicator 297 may show thereon a current status (e.g., a booting status, a message status, or a recharging status) of the electronic device 201 or of its part (e.g., the AP 210). The motor 298 may convert an electric signal into a mechanical vibration. Although not shown, the electronic device 201 may include a specific processor (e.g., GPU) for supporting a mobile TV. This processor may process media data that comply with standards of DMB (Digital Multimedia Broadcasting), DVB (Digital Video Broadcasting), or media flow.

Each of the above-discussed elements of the electronic device disclosed herein may be formed of one or more components, and its name may be varied according to the type of the electronic device. The electronic device disclosed herein may be formed of at least one of the above-discussed elements without some elements or with additional other elements. Some of the elements may be integrated into a single entity that still performs the same functions as those of such elements before integrated.

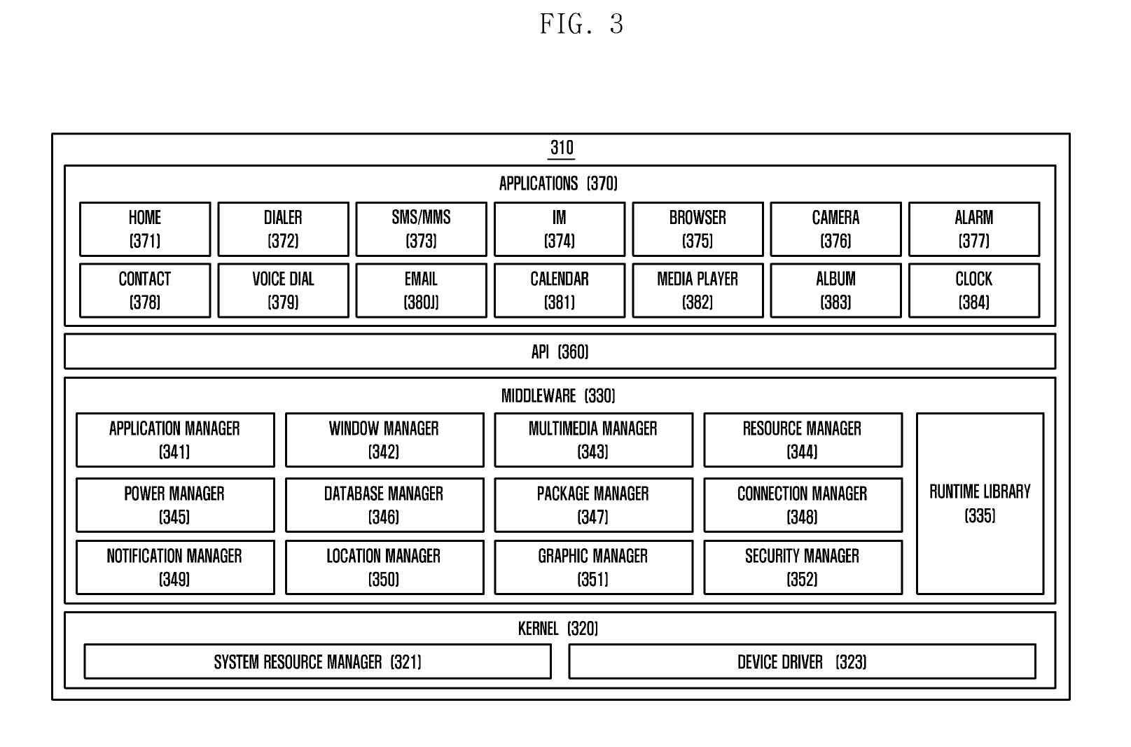

FIG. 3 is a block diagram illustrating a program module according to various exemplary embodiments.

According to an embodiment of the present disclosure, a program module 310 (for example, the program 140) may include an Operating System (OS) for controlling resources related to an electronic device (for example, the electronic device 101) and/or various applications (for example, the application program 147) executed in the operating system. The operating system may be, for example, Android, iOS, Windows, Symbian, Tizen, Bada, or the like.

The program module 310 may include a kernel 320, middleware 330, an API 360, and/or an application 370. At least some of the program module 310 may be preloaded on the electronic device, or may be downloaded from an external electronic device (e.g., the electronic device 102 or 104, or the server 106).

The kernel 320 (e.g., the kernel 141) may include, for example, a system resource manager 321 and/or a device driver 323. The system resource manager 321 may perform the control, allocation, retrieval, or the like of system resources. According to one embodiment of the present disclosure, the system resource manager 321 may include a process management unit, a memory management unit, or a file system management unit. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

For example, the middleware 330 may provide a function required in common by the applications 370, or may provide various functions to the applications 370 through the API 360 so as to enable the applications 370 to efficiently use the limited system resources within the electronic device. According to an embodiment, the middleware 330 (for example, the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module that a complier uses to add a new function by using a programming language during the execution of the application 370. The runtime library 335 may perform input/output management, memory management, the functionality for an arithmetic function, or the like.

The application manager 341 may manage, for example, the life cycle of at least one of the applications 370. The window manager 342 may manage Graphical User Interface (GUI) resources used for the screen. The multimedia manager 343 may determine a format required to reproduce various media files, and may encode or decode a media file by using a coder/decoder (codec) appropriate for the relevant format. The resource manager 344 may manage resources, such as a source code, a memory, a storage space, and the like of at least one of the applications 370.

The power manager 345 may operate together with a Basic Input/Output System (BIOS) to manage a battery or power and may provide power information required for the operation of the electronic device. The database manager 346 may generate, search for, and/or change a database to be used by at least one of the applications 370. The package manager 347 may manage the installation or update of an application distributed in the form of a package file.

The connectivity manager 348 may manage a wireless connection such as, for example, Wi-Fi or Bluetooth. The notification manager 349 may display or notify of an event, such as an arrival message, an appointment, a proximity notification, and the like, in such a manner as not to disturb the user. The location manager 350 may manage location information of the electronic device. The graphic manager 351 may manage a graphic effect, which is to be provided to the user, or a user interface related to the graphic effect. The security manager 352 may provide various security functions required for system security, user authentication, and the like. According to an embodiment of the present disclosure, when the electronic device (for example, the electronic device 101) has a telephone call function, the middleware 330 may further include a telephony manager for managing a voice or video call function of the electronic device.

The middleware 330 may include a middleware module that forms a combination of various functions of the above-described elements. The middleware 330 may provide a module specialized for each type of OS in order to provide a differentiated function. Also, the middleware 330 may dynamically delete some of the existing elements, or may add new elements.

The API 360 (e.g., the API 145) is, for example, a set of API programming functions, and may be provided with a different configuration according to an OS. For example, in the case of Android or iOS, one API set may be provided for each platform. In the case of Tizen, two or more API sets may be provided for each platform.

The application 370 (for example, the application 134) may include one or more applications capable of performing a function of, for example, a home 371, a dialer 372, SMS/MMS 373, an Instant Message (IM) 374, a browser 375, a camera 376, an alarm 377, a contact 378, a voice dialer 379, an email 380, a calendar 381, a media player 382, an album 383, and a clock 384. Additionally or alternatively, the application 370 may include one or more applications capable of performing a function of, for example, health care (for example, a measurement of an exercise quantity or blood sugar) or environment information provision (for example, provision of atmospheric pressure, humidity, or temperature information).

According to an embodiment of the present disclosure, the applications 370 may include an application (hereinafter, referred to as an “information exchange application” for the convenience of description) supporting information exchange between the electronic device (e.g., the electronic device 101) and an external electronic device (e.g., the electronic device 102 or 104). The application associated with information exchange may include, for example, a notification relay application for forwarding specific information to an external electronic device, or a device management application for managing an external electronic device.

For example, the notification relay application may include a function of delivering, to the external electronic device (e.g., the electronic device 102 or 104), notification information generated by other applications (e.g., an SMS/MMS application, an email application, a health care application, an environmental information application, etc.) of the electronic device 101. Further, the notification relay application may receive notification information from, for example, an external electronic device and provide the received notification information to a user.

The device management application may manage (for example, install, delete, or update), for example, a function for at least a part of the external electronic device (for example, the electronic device 104) communicating with the electronic device (for example, turning on/off the external electronic device itself (or some elements thereof) or adjusting brightness (or resolution) of a display), applications executed in the external electronic device, or services provided from the external electronic device (for example, a telephone call service or a message service).

According to an embodiment of the present disclosure, the application 370 may include an application (e.g., a health care application of a mobile medical device or the like) designated according to an attribute of the external electronic device (e.g., the electronic device 102 or 104). According to an embodiment, the applications 370 may include an application received from the external electronic device (for example, the server 106, or the electronic device 102 or 104). According to an embodiment of the present disclosure, the applications 370 may include a preloaded application or a third party application that may be downloaded from a server. The names of the elements of the program module 310 may vary according to the type of operating system.

According to various embodiments, at least a part of the programming module 310 may be implemented in software, firmware, hardware, or a combination of two or more thereof. At least some of the program module 310 may be implemented (e.g., executed) by, for example, the processor (e.g., the AP 210). At least some of the program module 310 may include, for example, a module, a program, a routine, a set of instructions, and/or a process for performing one or more functions.

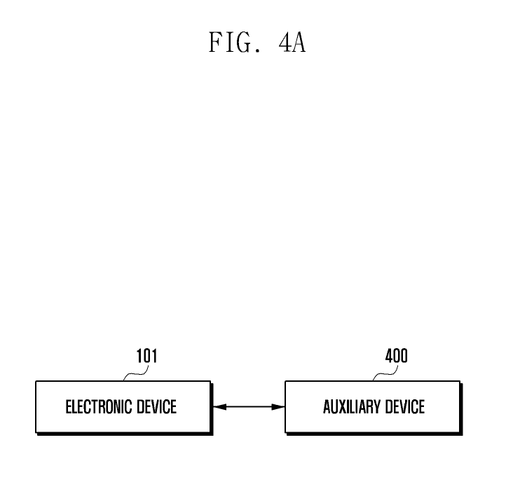

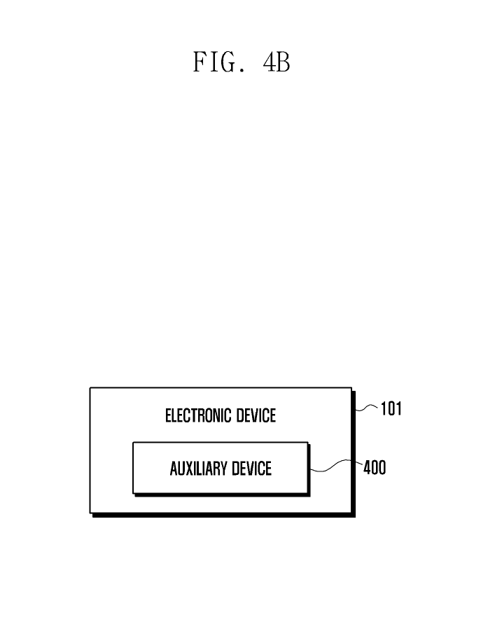

FIG. 4A is a diagram of an example of an electronic device and an auxiliary device according to various embodiments of the present disclosure. In an embodiment, as illustrated in FIG. 4A, the electronic device 101 and the auxiliary device 400 may be separate devices that can be independently configured. For example, if the electronic device 101 is a portable phone terminal, the auxiliary device 400 may be configured as a case that is connectable to the portable phone terminal. As another example, if the electronic device 101 is a wearable device, such as a smart watch, the auxiliary device 400 may correspond to a strap portion of the smart watch, but is not limited thereto. The electronic device 101 and the auxiliary device 400 according to various embodiments of the present disclosure may be configured by various devices.

FIG. 4B is a diagram of an example of an electronic device and an auxiliary device, according to various embodiments of the present disclosure. As illustrated in FIG. 4B, the auxiliary device 400 may be configured to be included in the electronic device 101. For example, the auxiliary device 400 may correspond to a part of the configuration of the electronic device 101 or may be formed to be physically connected to the electronic device 101 when the electronic device 101 is manufactured, but is not limited thereto. The auxiliary device 400 according to various embodiments of the present disclosure may be configured by various devices that are functionally or physically included in the electronic device 101.

The auxiliary device 400 may include at least one of a connection portion 420 and a deformable portion 410. According to various embodiments, since the connection portion 420 and the deformable portion 410 are functionally divided portions, they may be configured into one portion. According to circumstances, the auxiliary device 400 may be configured so that the connection portion 420 and the deformable portion 410 are configured into one portion. In addition, the auxiliary device 400 may include a separate processor, a communication module, a storage portion, an input/output interface, and a power module in addition to the connection portion 420 and the deformable portion 410. However, the various embodiments of the present disclosure are not limited thereto, and the auxiliary device 400 may include various configurations of the electronic device 101 disclosed in FIGS. 1 to 3.

In various embodiments, the connection portion 420 may be variously configured to perform physical, magnetic, electrical, or communicational connection with the electronic device 101. Through the connection portion 420, the auxiliary device 400 can be connected to the electronic device 101 by wire or wirelessly. For example, the auxiliary device 400 may be physically, electrically, or magnetically connected to the electronic device 101 through the connection portion 420 of the auxiliary device 400. In addition, the auxiliary device may perform wired or wireless communication with the electronic device 101 through the connection portion 420 that is composed of various communication modules (NFC module and the like).

In various embodiments, the deformable portion 410 may be a specific region of the auxiliary device 400. The deformable portion 410 may be implemented in various shapes in accordance with the physical deformation. For example, the deformable portion 410 may be implemented by a one-time configuration that is folded, torn, or separated by user's operation. For example, the deformable portion 410 may be implemented by a region that is not restored to its previous state once the physical deformation thereof occurs, but is not limited thereto. The deformable portion 410 according to various embodiments of the present disclosure may be implemented in various shapes that can be restored to the original state after the physical deformation thereof occurs.

In an embodiment, the auxiliary device 400 may include a connection portion 420 connected to the electronic device 101, and a deformable portion 410 including at least a partial region of the auxiliary device 400 to be deformed in accordance with an external pressure and to provide an input that is generated in accordance with the deformation to the electronic device 101 through the connection portion 420. In various embodiments, the connection portion 420 and the deformable portion 410 that are disclosed in the following drawings may have various sizes, locations, and shapes in accordance with the kind of the electronic device 101 or the auxiliary device 400.

In an embodiment, the deformable portion 410 of the auxiliary device 400 may be configured so that at least any one of a hardness value and a physical deformation limit value of the deformable portion 410 is different from that of a region excluding the deformable portion 410 of the auxiliary device 400. For example, the deformable portion 410 may be configured so that at least one of the hardness value and the physical deformation limit value of the deformable portion 410 is higher or lower than that of the region excluding the deformable portion 410, for example, the region that is adjacent to the deformable portion 410.

In another embodiment, the deformable portion 410 of the auxiliary device 400 may be made of a material that is different from the material of the region excluding the deformable portion 410 of the auxiliary device 400, for example, the region that is adjacent to the deformable portion 410.

In an embodiment, the connection portion 420 of the auxiliary device 400 may be electrically connected to the electronic device 101, and a channel that is electrically connected through the connection portion 420 may be extended so that at least a part of the extended channel may be mounted on one side of the deformable portion 410. The deformable portion 410 may provide an electrical signal that is generated from a channel in accordance with an external pressure that is applied to the deformable portion to the connection portion 420 as an input for the electronic device 101.

In an embodiment, the auxiliary device 400 may include an element that is provided on the deformable portion 410. For example, the auxiliary device 400 may be configured so that an element is mounted on one side of the deformable portion 410 of the auxiliary device 400. Such an element may generate a signal in accordance with a predetermined external pressure and may provide the generated signal to the connection portion 420 as an input for the electronic device 101.

In an embodiment, the auxiliary device 400 may include a magnetic element. The deformable portion 410 may provide a magnetic signal that is generated on the basis of the magnetic element in accordance with a defined physical deformation to the electronic device 101. For example, in the case where the magnetic element of the auxiliary device 400 comes into contact with or approaches the magnetic sensor 240D of the electronic device 101 in accordance with the physical deformation of the magnetic element of the auxiliary device 400, the electronic device 101 may receive an input based on the physical deformation of the auxiliary device 400 and may sense the magnetic signal that is generated on the basis of the input.

In an embodiment, if the deformation occurs, the deformable portion 410 of the auxiliary device 400 may not be restored to the physical state prior to the deformation.

In an embodiment, the auxiliary device 400 may further include a pressing portion. The pressing portion may be adjacent to the deformable portion 410 of the auxiliary device 400. For example, the auxiliary device 400 may further include the pressing portion that can physically press at least a partial region of the electronic device 101. The auxiliary device 400 may create it as the input for the electronic device that the pressing portion comes in physical contact with the input/output interface of the electronic device 101 in accordance with the physical deformation of the deformable portion 410 based on the external pressure for the pressing portion. The auxiliary device 400 may provide such an input to the electronic device 101.

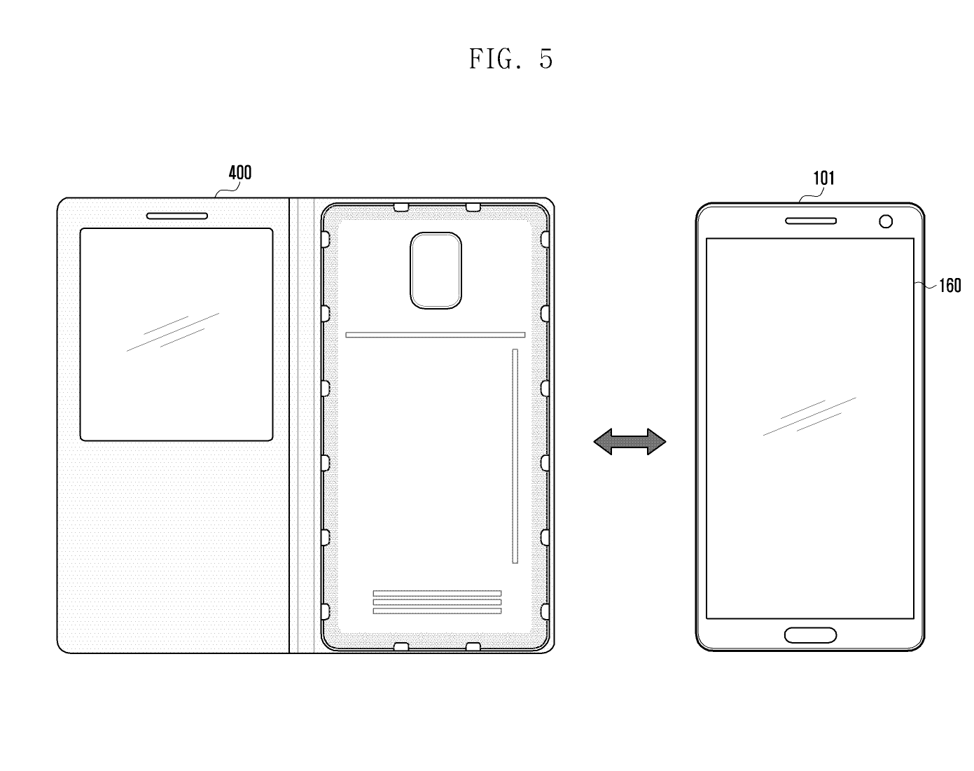

FIG. 5 is a diagram of an example of an electronic device and an auxiliary device, according to various embodiments of the present disclosure. As illustrated, the electronic device 101 according to an embodiment may be connected to the auxiliary device 400 by wire or wirelessly. The electronic device 101 may establish an electrical connection with the auxiliary device 400. For example, the electronic device 101 may include various types of circuit modules mounted on one side of the electronic device 101 that are electrically connectable to the auxiliary device 400. The auxiliary device 400 may include other circuit modules mounted on one side of the auxiliary device 400 to correspond to the circuit modules of the electronic device 101. The electronic device 101 and the auxiliary device 400 according to an embodiment may include at least one metal contact mounted thereon, and may be connected to each other through a connection between the metal contacts. In addition, a Near Field Communication (NFC) module 228 may be mounted on one side of the electronic device 101, and a chip that corresponds to the NFC module 228 may be mounted on the auxiliary device 400. The auxiliary device 400 according to various embodiments may be a case type device having an exposed front surface that corresponds to the screen of the electronic device 101 and surrounding the side surface and the rear surface of the electronic device 101, a reception type device capable of receiving the electronic device 101 therein, or a flip cover coupled to the rear surface or side surface of the electronic device 101 and having a cover for protecting the front surface that corresponds to the screen of the electronic device 101.

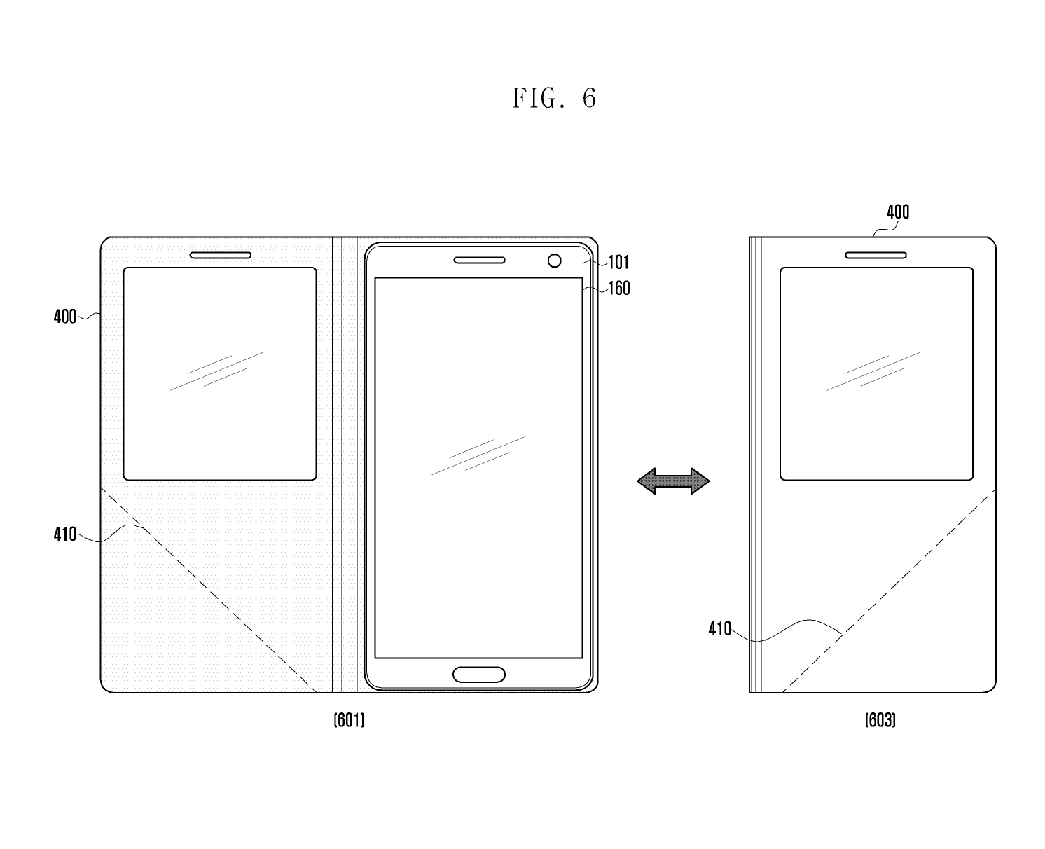

FIG. 6 is a diagram of an example of an electronic device and an auxiliary device, according to various embodiments of the present disclosure. More particularly, FIG. 6 illustrates an electronic device 101 and an auxiliary device 400 including a deformable portion 410.

Referring to 601 and 603 of FIG. 6, the electronic device 101 may be connected to the auxiliary device 400. The deformable portion 410 may be configured so that at least any one of a hardness value and a physical deformation limit value of the deformable portion 410 is different from that of another portion of the auxiliary device 400. For example, the deformable portion 410 may be configured so that at least one of the hardness value and the physical deformation limit value of the deformable portion 410 is higher or lower than that of the other portion of the auxiliary device 400. Here, the hardness value may be a resistant force level value against the physical deformation.

For example, the deformation limit value may be the maximum value of a restoration value to return to the original shape when an external force is applied as the pressure. For example, if the hardness value of the deformable portion 410 of the auxiliary device 400 is 10 kg, the hardness value of the other portion of the auxiliary device 400 excluding the deformable portion 410 may be 30 kg. As an additional example, if the deformation limit value of the deformable portion 410 of the auxiliary device 400 is 1 kg, the deformation limit value of the other portion of the auxiliary device 400 excluding the deformable portion 410 may be 5 kg.

The deformable portion 410 of the auxiliary device 400 according to an embodiment may be made of a different material that the material from which the other portion is made. In FIGS. 5 to 8, the auxiliary device 400 may be a case that receives the portable terminal type electronic device 101, and in this case, a region of the auxiliary device 400 that covers the front surface of the electronic device 101 may be defined as a cover portion. Accordingly, the cover portion may include the deformable portion 410 provided on at least a partial region thereof. The cover portion that forms the auxiliary device 400 may be made of at least one or both of a hard material and a soft material. For example, the cover portion of the auxiliary device 400 may be made of at least one of chamude, artificial leather, suede fabric, microfiber rubber, urethane, silicon, leather, synthetic leather, and fiber. For example, the cover portion except for the deformable portion 410 may be made of a hard material, and only the deformable portion 410 may be made of a soft material. The deformable portion 410 according to an additional embodiment may be changed.

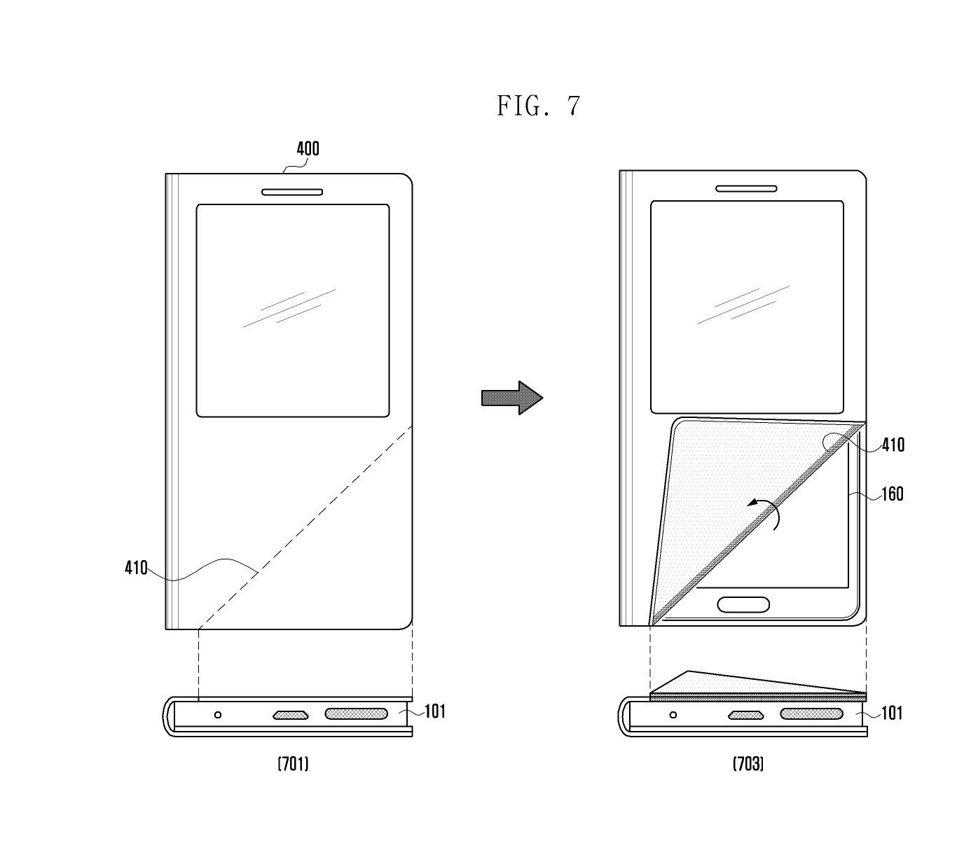

FIG. 7 is a diagram of an example of an electronic device and an auxiliary device including a deformable portion, according to various embodiments of the present disclosure. More particularly, FIG. 7 illustrates an electronic device 101 and an auxiliary device 400 including a deformable portion 410.

Referring to 701 and 703, the cover portion of the auxiliary device 400 may be physically deformed by a force that exceeds a pressure threshold and is applied to the auxiliary device 400 including the deformable portion 410. For example, if a force that exceeds the pressure threshold is applied to the cover portion, for example, from a right lower end to a left upper end thereof around the auxiliary device 400, physical deformation of the cover portion may occur around the deformable portion 410.

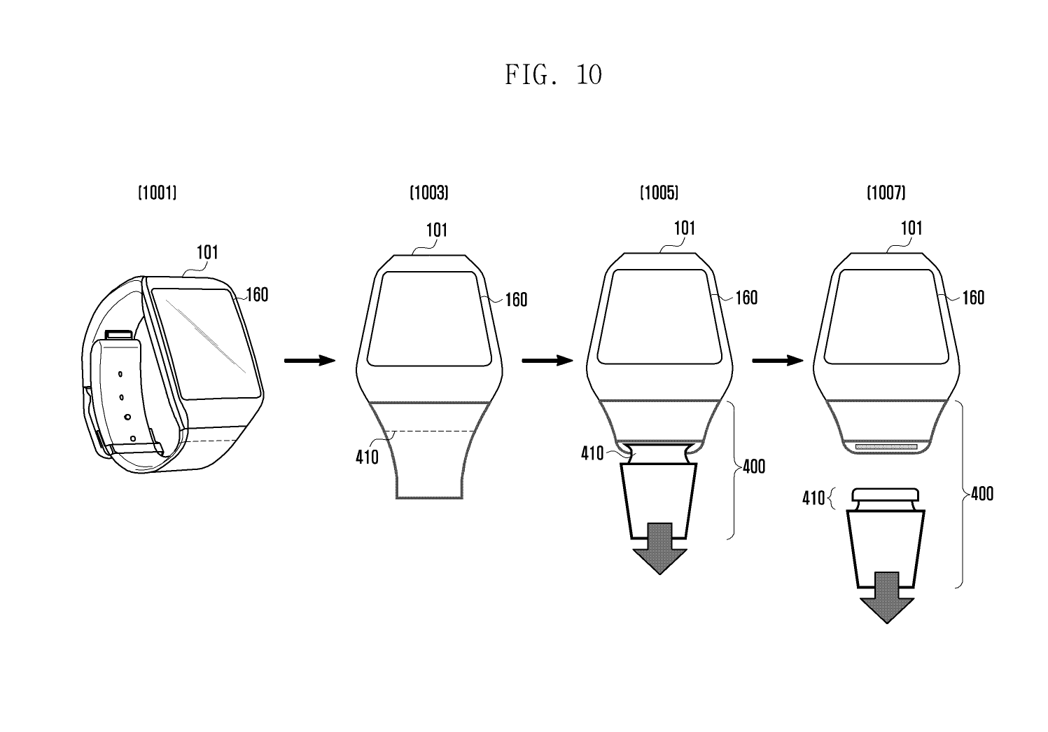

In response to detecting the physical deformation, the processor 120 may perform a predetermined function. For example, the processor 120 may initiate a telephone call by using a predetermined phone number, transmit information through a predetermined communication channel, and output a sound. However, the operation of the processor 120 is not limited to the aforementioned examples, and the processor 120 may perform predetermined functions that can be variously performed in accordance with the physical deformation of the cover portion. Further, embodiments in which the electronic device 101 includes a wearable device will be described later with reference to FIG. 10.

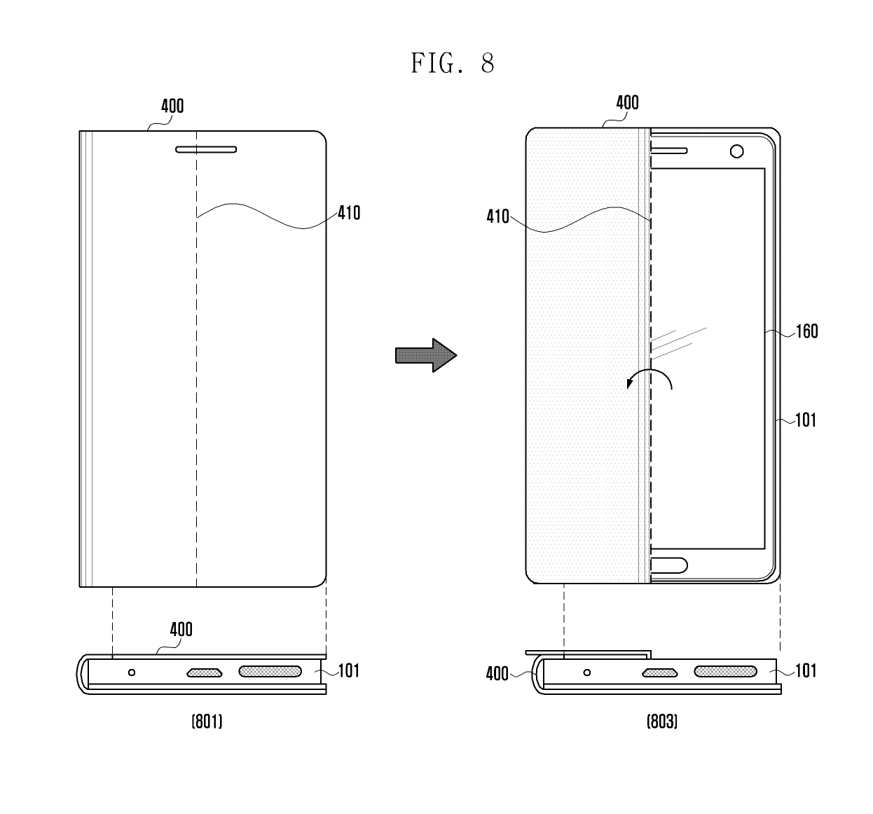

FIG. 8 is a diagram of an example of an electronic device and an auxiliary device including a deformable portion, according to various embodiments of the present disclosure. More particularly, FIG. 8 illustrates an electronic device 101 and an auxiliary device 400 including a deformable portion 410.

Referring to 801 and 803, the cover portion of the auxiliary device 400 may be physically deformed by a force that exceeds the pressure threshold and is applied to the auxiliary device 400 including the deformable portion 410. For example, if a force that exceeds the pressure threshold is applied to the cover portion, for example, from a right end to a left end thereof around the auxiliary device 400, physical deformation of the cover portion may occur around the deformable portion 410. As another example, if a force that exceeds the pressure threshold is applied to the cover portion, for example, from the right end to the left end around the auxiliary device 400, the cover portion may be completely folded.

In response to detecting the physical deformation of the cover portion, the processor 120 may perform a predetermined function. For example, the processor 120 may initiate a telephone call by using a predetermined phone number, transmit information through a predetermined communication channel, or output of sound of a threshold level or more.

FIG. 9A is a diagram of an example of an electronic device and an auxiliary device, according to various embodiments of the present disclosure. More particularly, FIG. 9A illustrates the internal configuration of an electronic device 101 and an auxiliary device 400 including a deformable portion 410, according to various embodiments of the present disclosure. One channel (e.g., wire) illustrated in this drawing is not disclosed in FIG. 2, but may be included in the electronic device 101 and the auxiliary device 400.

The electronic device 101 according to an embodiment of the present disclosure may supply a voltage to one channel through the input/output interface 150. The channel may be connected to a resistor R1 and a resistor R2, and the processor 120 may control at least one of a power management module 295 and a battery 296 to supply the voltage to the input/output interface 150. For example, the input/output interface 150 may be mounted on one side of the electronic device 101, and may include an electrical contact that is connected to the auxiliary device 400.

The input/output interface 150 according to an embodiment of the present disclosure may be connected to the connection portion 420 of the auxiliary device 400. For example, the connection portion 420 may be a contact that is electrically connectable to the input/output interface 150 of the electronic device 101.

According to aspects of the disclosure, a channel (e.g., wire) that extends from the connection portion 420 may be mounted on one side of the auxiliary device 400. A resistor R3 may be additionally mounted on the auxiliary device 400. According to aspects of the disclosure, the channel may be at least partially disposed in the deformable portion 410. If physical deformation occurs on the deformable portion 410 as a result of external pressure being applied, the deformable portion 410 may open or deform the channel that passes through the deformable portion 410. Afterwards, the auxiliary device 400 may provide a voltage or current change signal that occurs in the channel in accordance with such deformation to the electronic device 101.

In instances in which voltage is supplied, the processor 120 according to an embodiment of the present disclosure may apply the voltage only to the resistor R1 due to the existence (e.g., short state) of the channel that passes through the deformable portion 410. The processor 120 may detect that the external pressure is not currently applied to the deformable portion 410 through sensing of the voltage that is applied only to the resistor R1. In another embodiment, if the physical deformation of the deformable portion 410 occurs in accordance with the external pressure and the channel that passes through the deformable portion 410 is opened, the processor 120 may detect that the external pressure is currently applied to the deformable portion 410 through sensing of the voltage that is divided by R1, R2, and R3.

FIG. 9B is a diagram of an example of a circuit for detecting that an auxiliary device is deformed, according to various embodiments of the present disclosure. As illustrated, a portion of the circuitry may be integrated into the electronic device 101, while another portion of the circuit may be integrated into an auxiliary device 400. One channel (e.g., wire) illustrated in this drawing is not shown in FIG. 2, but may be included in the electronic device 101 and the auxiliary device 400.

The processor 120 according to an embodiment of the present disclosure may apply a voltage through the one channel (e.g., wire). The channel that passes through a deformable portion 410 according to an embodiment may be in an open (e.g., electrically open) state or in a switch open state due to the physical deformation of the deformable portion 410 included in the cover portion of the auxiliary device 400.

If a voltage is applied, the channel that passes through the deformable portion 410 becomes in an open or switch open state, and the processor 120 according to an embodiment may apply the voltage to the resistor R3 mounted on the auxiliary device 400. As the voltage is applied to the respective resistors, the processor 120 may detect that the external pressure is currently applied to the deformable portion 410. For example, the processor 120 may compare a voltage that is applied only to R1, a voltage that is applied only to R1 and R2, and a voltage that is applied to R1, R2, and R3 with each other. If the voltage is applied only to R1, the processor 120 may detect that the external pressure is not currently applied to the deformable portion 410. Further, if the voltage is applied only to R1 and R2, the processor 120 may detect that the electronic device 101 and the auxiliary device 400 are currently in a separated state. Further, if the voltage is applied to R1, R2, and R3, the processor 120 may detect that the external pressure is currently applied to the deformable portion 410.

The processor 120 may detect that information on the received voltage is a voltage corresponding to a predetermined function, and may perform the predetermined function (e.g., call request to a predefined phone number). FIG. 10 is a diagram of an example of an electronic device 101 and a strap type auxiliary device 400, according to various embodiments of the present disclosure.

Referring to 1001 and 1003, the electronic device 101 according to an embodiment of the present disclosure may be a wearable device such as a smart watch. Here, the auxiliary device 400 may include the deformable portion 410, which may be included in a strap (e.g., string or belt for fixing a specific device) component connected to the electronic device 101.

Referring to 1005 and 1007, if a force that exceeds a defined pressure threshold is applied to the deformable portion 410 included in the strap that is the auxiliary device 400 and the physical deformation of the deformable portion 410 occurs (e.g., at least a defined part of the strap is separated), the electronic device 101 may perform a predetermined function. The predetermined function may include at least one of initiating a telephone call to a predefined phone number and transmitting of information through a predefined communication channel (transmission of an emergency signal to a connected portable terminal).

For example, the electronic device 101 may detect that it is connected to the auxiliary device 400 or at least a defined part of the strap is separated through mounting of the channel (e.g., wire) on one side of the auxiliary device 400 that includes the deformable portion 410.

Although in the example of FIG. 10 the wearable device is a smart watch, it will be understood that the electronic device 101 may include any suitable type of wearable device. In various embodiments, the wearable device may include at least one of an accessory device (e.g., an electronic ring, an electronic bracelet, an electronic ankle bracelet, an electronic necklace, electronic glasses, contact lens, or Head-Mounted Device (HMD)), a textile or clothing integration type (e.g., electronic clothes), a body attachment type of device (e.g., skin pad or tattoo), and an implantable device (e.g., an implantable circuit). The wearable device may include the constituent elements of the electronic device 101 according to an embodiment of the present disclosure (e.g., processor, memory, bus, input/output interface, display, and communication interface). In addition, the above-described constituent elements are not essential, and various configurations may be added to or omitted from the wearable device according to various embodiments of the present disclosure.

FIG. 11 is a diagram of an example an electronic device 101 and an auxiliary device 400 including an element that performs a specific function, according to various embodiments of the present disclosure. One channel (e.g., wire) illustrated in this drawing is not disclosed in FIG. 2, but may be included in the electronic device 101 and the auxiliary device 400.

The electronic device 101 and the auxiliary device 400 according to an embodiment of the present disclosure may be electrically connected to one another. The input/output interface 150 according to an embodiment of the present disclosure may be connected to the connection portion 420 of the auxiliary device 400.

On at least a part of the auxiliary device 400 according to an embodiment, an element 450 may be mounted, which generates a signal (voltage) if a pressure that exceeds a predefined pressure is applied to the deformable portion 410 or predefined physical deformation occurs in the deformable portion 410. For example, if a pressure that exceeds the predefined pressure is sensed through the element 450 that is mounted on at least a part of the deformable portion 410, the auxiliary device 400 may generate a signal (voltage) and may transfer the generated signal (voltage) to the electronic device 101 through a channel (e.g., a wire) that is coupled to the element 450.

The input/output interface 150 according to an embodiment of the present disclosure may feed the received signal (voltage) to the processor 120. The processor 120 may perform an operation that corresponds to the received signal (voltage). For example, the processor 120 may initiate a telephone call by using a predefined phone number or transmit defined information through a predefined communication channel.

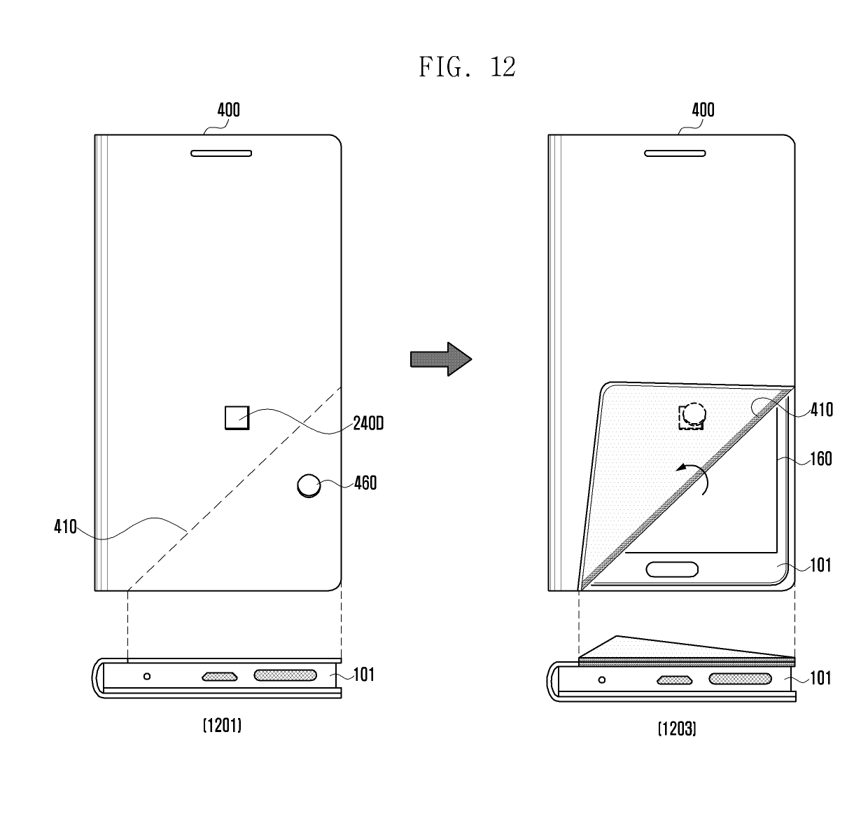

FIG. 12 is a diagram of an example of an electronic device 101 and an auxiliary device 400 including a magnetic element 460, according to various embodiments of the present disclosure.

The electronic device 101 according to an embodiment of the present disclosure may include a magnetic sensor 240D that is mounted on one region of the electronic device 101. The auxiliary device 400 may include a magnetic element 460 that is mounted in at least one region of the auxiliary device 400. If physical deformation occurs in the deformation region 410 included in the auxiliary device 400, the magnetic sensor 240D may become adjacent to the magnetic element 460. The magnetic sensor 240D that is adjacent to the magnetic element 460 may measure the magnitude of a magnetic force that is exerted on the magnetic element 460.

The magnetic sensor 240D may transfer to the processor 120 a signal that is based on the measured magnitude of the magnetic force. The processor 120 may perform a predefined function based on the received value of magnetism.

In an embodiment, the magnetic sensor 240D may not be configured separately from the input/output interface 150, but may be included in the input/output interface 150. For example, the input/output interface 150 according to various embodiments of the present disclosure may include a magnetic region that generates a magnetic signal corresponding to the magnetic element 460 when the magnetic region becomes positioned within a predetermined distance from the magnetic element 460 of the auxiliary device 400.

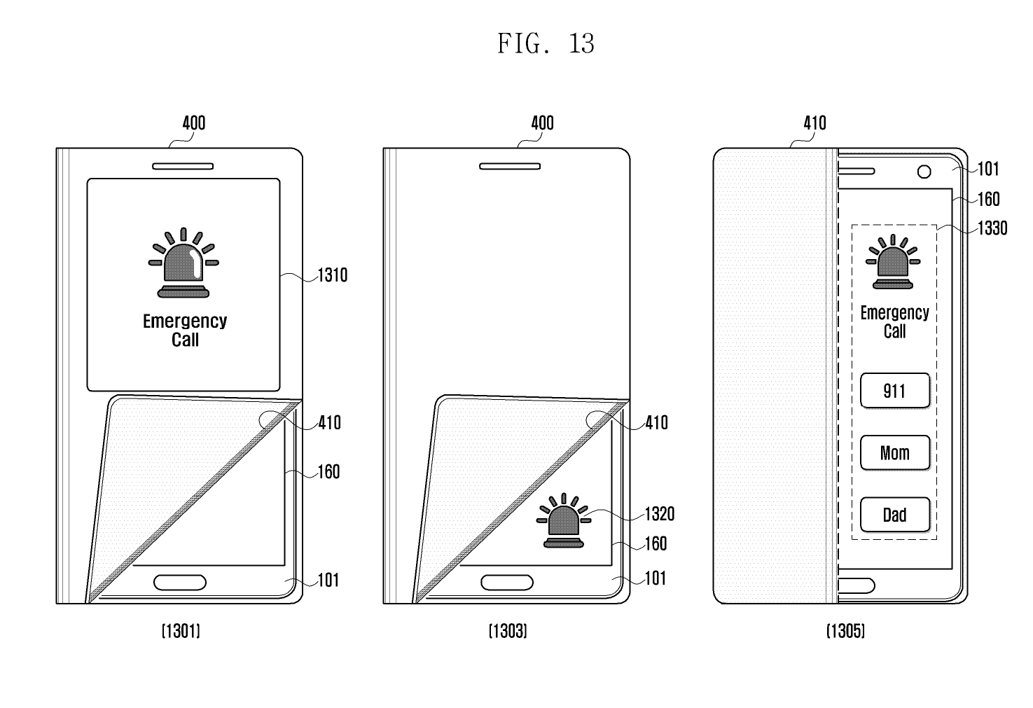

FIG. 13 is a diagram of an example of an electronic device 101 and an auxiliary device 400 including a deformable portion 410, according to various embodiments of the present disclosure.

If at least one sensed signal satisfies the predefined condition, the processor 120 according to an embodiment of the present disclosure may display a graphic user interface in one region of the display 160.

The processor 120 according to an embodiment may determine the kind of the auxiliary device 400 when it is connected to the auxiliary device 400, and may perform a function that corresponds to the kind of the auxiliary device 400. For example, information for the kind of the auxiliary device 400 (e.g., shape in accordance with the kind of the cover portion or graphic user interface to be displayed) may be stored in the memory 130. Further, information related to the auxiliary device 400 that is received from an external server may be stored in the memory 130.

Referring to 1301, the processor 120 may identify the kind of the auxiliary device 400 that can be displayed on one region of the display 160 and may display an emergency mode user interface 1310 in the one region of the display 160 based on the identified kind of the auxiliary device 400.

The processor 120 may confirm the one region of the display 160 from which the auxiliary device 400 is not located within a predetermined threshold distance. For example, the processor 120 may determine the location of the auxiliary device 400 through a touch screen panel, a proximity sensor, or an infrared sensor provided on one side of the electronic device 101. Such determination is provided only as an example, and the disclosure is not limited to the aforementioned examples. For example, the processor 120 may determine a display region that is exposed to an outside based on inherent chip identification information ID included in the auxiliary device 400. Specifically, the processor 120 may collect the inherent chip identification information ID or attribution information included in the auxiliary device, compare the collected information with pre-stored information, and identify the region of the display 160 exposed to the outside based on the compared information. In some implementations, the pre-stored information for the comparison may be received from another electronic device 102 or 104 or a server 106 through a network. In various embodiments, the processor 120 may identify the region of the display 160 that is exposed to the outside based on the identification information ID received from the auxiliary device 400, and may output a corresponding user interface UI to the exposed region of the display 160 that corresponds to the predefined function. The processor 120 may control the display 160 to display the predetermined graphic user interface in the identified region.

Referring to 1303, if the one region of the cover portion of the auxiliary device 400 is physically deformed, the processor 120 may display an emergency mode user interface 1320 on the confirmed region.

Referring to 1305, if the physical deformation occurs in the deformation region 410 of the auxiliary device 400, the processor 120 may display items 1330 in the identified region. For example, the processor 120 may display the emergency mode user interface and image items (e.g., 911, daddy's phone number, and mom's phone number) corresponding to pre-stored phone numbers.

FIG. 14 is a diagram of an example of an electronic device 101 and an auxiliary device 400 including a deformable portion 410, according to various embodiments of the present disclosure.

Referring to 1401, the auxiliary device 400 according to an embodiment of the present disclosure may include the deformable portion 410 in which physical deformation may occur due to physical pressure applied thereto. If a force that exceeds a pressure threshold is applied onto the deformable portion 410 that corresponds to at least a part of the auxiliary device 400 to cause physical deformation to occur, an input reception portion 157 may be pressed by the pressing portion 470 that is formed to project from one side thereof. Through such an operation, the deformable portion 410 may be unable to be restored to a state prior to the occurrence of the physical deformation. For example, due to the physical deformation, the deformable portion 410 may be separated from the auxiliary device 400. For example, the input reception portion 157 may correspond to a configuration that is included in the input/output interface 150 or a configuration that is connected to the input/output interface 150 to transfer the received input to the input/output interface 150. The input reception portion 157 may come in physical contact with the auxiliary device 400. The input reception portion 157 may generate a signal (e.g., electrical signal) when the deformable portion is pressed and may transfer information related to the generated signal to the processor 120.

Referring to 1403, the processor 120 may perform a predetermined function based on the received information.

FIG. 15 is a diagram of an example of an electronic device 101 and an auxiliary device 400 including a deformable portion 410, according to various embodiments of the present disclosure.

Referring to 1501, the auxiliary device 400 according to an embodiment of the present disclosure may include a first deformable portion 410a and a second deformable portion 410b in which physical deformation may occur due to physical pressure applied thereto. If a force that exceeds a pressure threshold is applied onto the first deformable portion 410a and the second deformable portion 410b, an input reception portion 157 may be pressed by the pressing portion 470. For example, the first deformable portion 410a may be configured to be restored to a location prior to the pressing by the physical input that is pressed again after being pressed. Specifically, the first deformable portion 410a may be pressed by a user to break a tube that is the second deformable portion 410b. Next, a restoration portion 479 may guide the first deformable portion 410a to be restored to the location prior to the deformation. The restoration portion 479 may be made of various materials or have various shapes, and for example, may be made from an elastic material. In addition, the first deformable portion 410a may be implemented by a button type configuration that can be restored to the original location by a plurality of pressure inputs.

Further, the second deformable portion 410b, unlike the first deformable portion 410a, may be implemented not to be restored again once it is deformed. For example, the second deformable portion 410b may be implemented in the form of a tube that is broken by the pressing force. In such instances, a user may replace the second deformable portion 410b that is deformed to be unable to be restored by a new second deformable portion. The input reception portion 157 may generate an electrical signal when it is pressed by the first deformable portion 410a and the second deformable portion 410b and may transfer information related to the generated electrical signal to the processor 120.

Referring to 1503, the processor 120 may perform a predetermined function based on the received information.

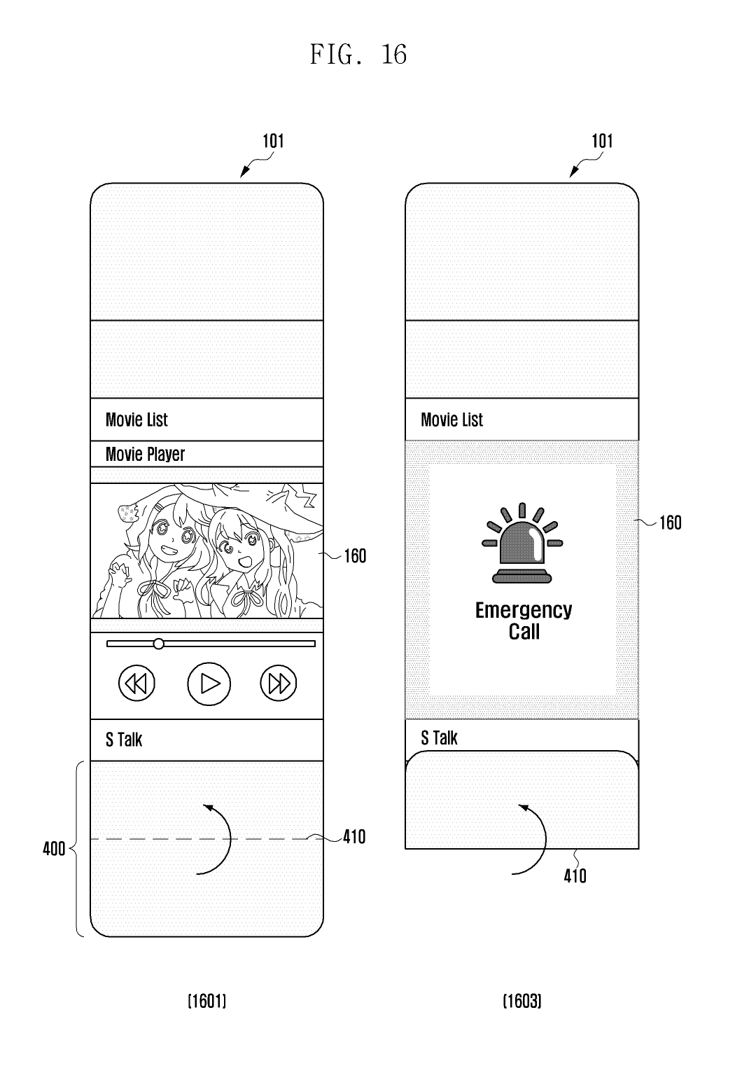

FIG. 16 is a diagram of an example of an electronic device 101 including a deformable portion 410, according to various embodiments of the present disclosure.

Referring to 1601, the electronic device 101 according to an embodiment of the present disclosure may be a flexible device including the deformable portion 410. In the example of FIG. 16, only the deformable portion 410 is added to the electronic device 101, but the present disclosure is not limited to this example. For example, the electronic device 101 may be configured to include the auxiliary device 400 having the deformable portion 410. In this case, the auxiliary device 400 may include only the deformable portion 410, and the deformable portion 410 may additionally perform the function of the connection portion 420.

The deformable portion 410 may be configured so that at least one of a hardness value and a physical deformation limit value of the deformable portion 410 is lower than that of the other region of the electronic device 101. For example, the hardness value may indicate resistance against physical deformation.

Here, the deformation limit value may be the maximum value of a restoration value to return to the original shape when an external force is applied as the pressure. For example, if the hardness value of the deformable portion 410 of the electronic device 101 is 10 kg, the hardness value of the other region of the electronic device 101 excluding the deformable portion 410 may be 30 kg. As an additional example, if the deformation limit value of the deformable portion 410 of the electronic device 101 is 1 kg, the deformation limit value of the other region of the electronic device 101 excluding the deformable portion 410 may be 5 kg.

The deformable portion 410 of the electronic device 101 according to an embodiment may be made of a different material from the material of the other region of the electronic device 101. For example, the other region of the electronic device 101 excluding the deformable portion 410 may be made of a high soft material, and only the deformable portion 410 may be made of a low soft material.

The deformable portion 410 of the electronic device 101 according to an embodiment may be configured to have a different folding attribute from the folding attribute of the other region. For example, the deformable portion 410 may be configured to fold at a different angle, direction, or strength from that of the other region excluding the deformable portion 410.

Referring to 1603, if a force that exceeds the predefined pressure threshold is applied to the deformable portion 410 in a predefined direction and a defined physical deformation occurs therein, the processor 120 may display an emergency mode user interface on the display 160, but is not limited thereto. The processor 120 may detect the physical deformation by using any suitable type of device, such as a bending sensor, an acceleration sensor, and geomagnetic sensor, and may initiate a call with another electronic device or another channel or transmit/receive information. Further, the processor 120 may control the audio module 280 to output predetermined sound.

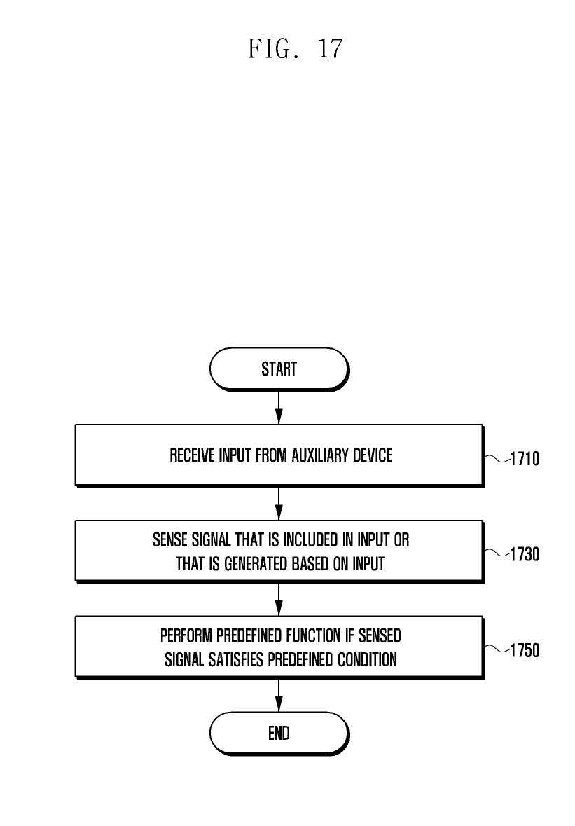

FIG. 17 is a flowchart of an example of a process, according to various embodiments of the present disclosure.

In operation 1710, the electronic device 101 may receive an input from the auxiliary device 400. The electronic device 101 may receive an input based on the physical deformation of the auxiliary device 400 from the auxiliary device 400. The processor 120 may receive the input from the auxiliary device 400 via the input/output interface 150. The electronic device 101 according to an embodiment may be connected to the auxiliary device 400 by wire or wirelessly. The electronic device 101 according to various embodiments may be electrically connected to the auxiliary device 400 through a channel, and may receive the electronic signal generated from the channel or the input including the electrical signal from the auxiliary device 400. The electronic device according to various embodiments may include a magnetic sensor 240D that is mounted on one side of the electronic device 101, and may receive the input including a magnetic signal from the auxiliary device 400 based on the magnetic element mounted on one side of the auxiliary device 400. The electronic device 101 according to various embodiments may come in physical (or magnetic) contact with the auxiliary device 400 through at least the projecting partial region of the auxiliary device 400 and may generate the electrical signal based on the contact input.

In operation 1730, the electronic device 101 may sense a signal that is included in the input or that is generated based on the input. Such a signal may include at least one of an electrical signal and a magnetic signal. For example, the processor 120 may sense at least one of the electrical signal and the magnetic signal from the input that includes at least one of the corresponding electric signal and magnetic signal. As another example, the input/output interface 150 may receive the physical input (e.g., pressure input by the pressing portion) of the auxiliary device 400, and may generate and transmit an electrical signal to the processor 120.

In operation 1750, if at least any one of the sensed signals satisfies the predefined condition, the electronic device 101 may perform the predefined function. The electronic device 101 according to an embodiment may store a value (e.g., voltage value or magnetic value) that corresponds to the predefined value in the memory 130. The predefined value may include a reference value and can be used to determine whether the at least one sensed signal is a signal based on the predefined physical deformation of the predefined auxiliary device. The electronic device 101 may perform a predefined function based on the outcome of a comparison of the stored threshold value with the sensed value. For example, the predefined function may be a function to request a call connection to a predefined phone number or a function to transmit defined information through a predefined communication channel.

The electronic device 101 according to an embodiment of the present disclosure may detect the physical contact with the auxiliary device 400. The processor 120 may sense that at least a partial region (e.g., pressing portion of the auxiliary device) of the auxiliary device 400 presses the electronic device 101 and may receive a signal that is generated in accordance with the pressing. If the generated signal satisfies the predefined condition, the processor 120 may control the constituent elements of the electronic device 101 to perform the predefined functions.

The processor 120 according to an embodiment of the present disclosure may detect the connection to the auxiliary device 400. If at least one of the sensed signals satisfies the predefined condition, the processor 120 according to an embodiment may control the display 160 to display a graphic user interface in one region of the display 160.

The processor 120 according to an embodiment of the present disclosure may identify a region of the display 160 in which the auxiliary device 400 is not located within a predetermined threshold distance value from the display 160. The processor 120 according to an embodiment may control the display 160 to display the predefined graphic user interface in the identified region. For example, the processor 120 may determine the location or the shape of the auxiliary device 400 that covers one side of the display using a touch screen panel, a proximity sensor, an infrared sensor, or a hall sensor that is mounted on one side of the electronic device 101. This determination operation is exemplary, and various embodiments of the present disclosure are not limited thereto. For example, the processor 120 may determine a display region that is exposed to an outside in accordance with the defined physical deformation of the auxiliary device 400 based on inherent chip identification information ID included in the auxiliary device 400. Specifically, the processor 120 may collect inherent chip identification information ID or attribute information included in the auxiliary device and may compare the collected information with pre-stored information. The processor 120 may identify the region of the display 160 that is exposed to the outside in accordance with the defined physical deformation of the auxiliary device 400 based on the compared information. In this case, the pre-stored information for the comparison may be received from another electronic device 102 or 104 or a server 106 through a network. In various embodiments, the processor 120 may identify the region of the display 160 that is exposed to the outside in accordance with the defined physical deformation of the auxiliary device 400 on the basis of the identification information ID collected from the auxiliary device 400, and may output the corresponding user interface UI to the exposed region of the display 160 in accordance with the execution of the predefined function.

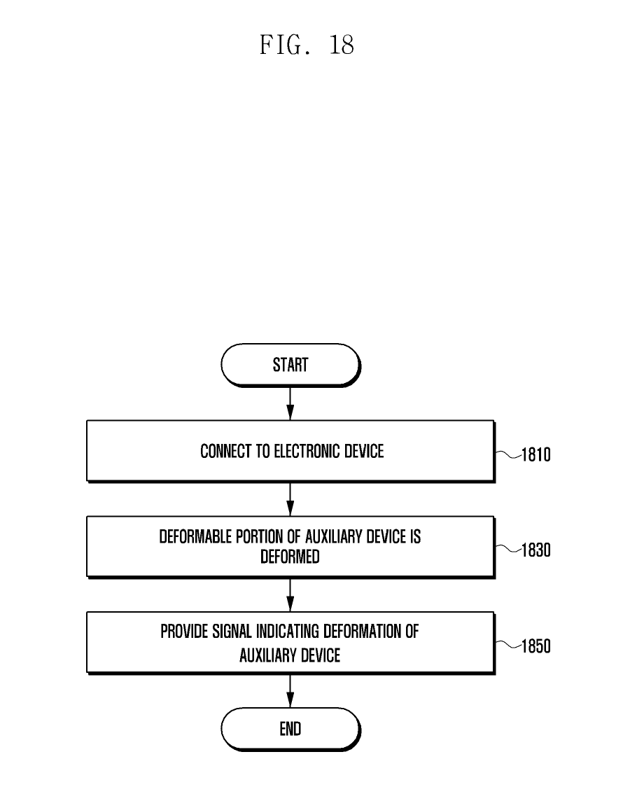

FIG. 18 is a flowchart of an example of a process, according to various embodiments of the present disclosure.

In operation 1810, the auxiliary device 400 may be connected to the electronic device. For example, the auxiliary device 400 may be electrically connected to the electronic device 101 through the connection portion 420 mounted on one side of the auxiliary device 400. For example, an electronic contact may be mounted on one side of the electronic device 101, and this electronic contact comes in contact with the connection portion 420 of the auxiliary device 400 to connect to the auxiliary device 400 and the electronic device 101 to each other, but is not limited thereto. As described above, through the connection portion 420 that is configured in various shapes, the auxiliary device 400 can be connected to the electronic device 101 by wire or wirelessly. For example, the auxiliary device 400 may be physically, electrically, or magnetically connected to the electronic device 101 through the connection portion 420 of the auxiliary device 400. In addition, the auxiliary device 400 may perform wired or wireless communication with the electronic device 101 through the connection portion 420 that is implemented by NFC or the like. Through this connection operation, the electronic device 101 may perform various embodiments in the drawings as described above.

In operation 1830, the deformable portion 410 of the auxiliary device 400 may be deformed as a result of the application of an external force on the auxiliary device 400. The external pressing may be physical pressure by a user's operation. For example, the deformable portion 410 may be folded, torn, or separated from the electronic device 101, and may have a structure that is not restored to the physical state prior to the deformation occurrence after the deformation occurs, but is not limited thereto. The deformable portion 410 according to various embodiments may be arranged to assume various shapes.

Referring to 1850, the auxiliary device may provide a signal that is generated in response to the deformation to the electronic device 101. For example, the auxiliary device 400 may provide the signal to the electronic device through the connection portion 420.

A method for generating a signal for requesting function performance of the auxiliary device 400 according to an embodiment of the present disclosure may include the connection portion 420 of the auxiliary device 400 connecting to the electronic device 101, the deformable portion 410 including at least a partial region of the auxiliary device 400 that is deformable, and providing an input that is generated in accordance with the deformation to the electronic device 101 through the connection portion 420.

The method for generating a signal for requesting the function performance of the auxiliary device 400 according to the present disclosure may include the connection portion 420 of the auxiliary device 400 electrically connecting to the electronic device 101, the deformation operation may include a channel that is mounted on one side of the deformable portion 410 and is electrically connected to the connection portion 420 generating an electrical signal in accordance with external pressure, and the providing operation may include the deformable portion 410 providing the generated electrical signal to the electronic device 101 as an input for the electronic device 101.

In the method for generating a signal for requesting the function performance of the auxiliary device 400 according to the present disclosure, the providing operation may include an element that is mounted on one side of the deformable portion 410 generating a signal in accordance with the predefined external pressure, and providing the generated signal to the connection portion 420 as the input for the electronic device.

In the method for generating a signal for requesting the function performance of the auxiliary device 400 according to the present disclosure, the modification portion 410 may include a magnetic element, and the providing operation may further include providing a magnetic signal that is generated based on the magnetic element in accordance with the deformation operation to the electronic device 101 as the input for the electronic device 101.

In the method for generating a signal for requesting the function performance of the auxiliary device 400 according to the present disclosure, the auxiliary device 400 may include a pressing portion mounted on one side of the auxiliary device 400 to physically press at least a partial region of the electronic device 101 in accordance with the deformation operation of the deformable portion 410, and the providing operation may include the pressing portion coming in physical contact with the input/output interface 150 of the electronic device 100 in accordance with the deformation operation of the deformable portion 410 based on external pressing for the pressing portion, and providing the contact as an input for the electronic device 101.

A system for performing a predefined function according to an embodiment of the present disclosure includes an electronic device 101 that receives an input from an auxiliary device 400 connectable to the electronic device 101, senses a signal that is included in the input or that is generated based on the input, and performs a predefined function if the sensed signal satisfies a pre-stored condition, and the auxiliary device 400 including a connection portion 420 connected to the electronic device 101, and a deformable portion 410 that includes at least a partial region of the auxiliary device 400, is deformed in accordance with external pressing, and provides the input that is generated in accordance with the deformation to the electronic device 101 through the connection portion 420.

The term “module” or “portion”, as used in the description of the present disclosure, may mean a unit that includes, for example, one of hardware, software, and firmware, or a combination of two or more thereof. The “module” or “portion” may be interchangeably used, for example, with the term, such as unit, logic, logical block, component, or circuit. The “module” or “portion” may be the minimum unit or a part of a component integrally formed. The “module” may be the minimum unit or a part thereof that performs one or more functions. The “module” or “portion” may be mechanically or electronically implemented. For example, the “module” or “portion” according to various embodiments of the present disclosure may include at least one of an Application-Specific Integrated Circuit (ASIC) chip, a Field Programmable Gate Array (FPGA) or a programmable logic device, which has been known or is to be developed, to perform certain tasks.

According to various embodiments, at least a part of devices (e.g., modules or their functions) or methods (e.g., operations) according to various embodiments of the present disclosure may be implemented by instructions that are stored in a computer readable storage medium in the form of programming modules. In the case where the instructions are executed by one or more processors (e.g., processors 120), the one or more processors may perform functions corresponding to the instructions. The computer readable storage medium may be, for example, the storage module 130.

The module or programming module according to various embodiments of the present disclosure may include one or more of the above-described constituent elements, a part thereof may be omitted, or other additional constituent elements may be further included therein. The operations that are performed by the module according to various embodiments of the present disclosure, the programming module, or other constituent elements may be performed in a successive, parallel, repetitive, or heuristic manner. Further, some operations may be executed in a different order or may be omitted, or other operations may be added.

FIGS. 1-18 are provided as an example only. At least some of the operations discussed with respect to these figures can be performed concurrently, performed in different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

Moreover, the embodiments disclosed in this specification are suggested for the description and understanding of technical content but do not limit the range of the present disclosure. Accordingly, the range of the present disclosure should be interpreted as including all modifications or various other embodiments based on the technical idea of the present disclosure.

What is claimed is:

1. An electronic device comprising:
a memory;
an input interface;
at least one processor operatively coupled to the memory, configured to:
receive a signal, via the input interface, that is generated in response to a physical deformation of an auxiliary device;
detect whether the signal satisfies a predefined condition; and
perform an operation associated with the predefined condition in response to the signal satisfying the predefined condition.

2. The electronic device according to claim 1, wherein:
the input interface is electrically connected to the auxiliary device, and
the signal includes an electrical signal.

3. The electronic device according to claim 1, wherein:
the input interface includes a magnetic sensor, and
the signal includes a magnetic signal.

4. The electronic device according to claim 1, wherein the operation is performed only once for the auxiliary device.

5. The electronic device according to claim 1, wherein:
the input interface is coupled to the auxiliary device via a wire-based channel, and
performing the operation includes at least one of initiating a telephone call by using a predefined telephone number and transmitting information by using a predefined communication channel.

6. The electronic device according to claim 5, wherein the predefined telephone number includes an emergency telephone number and the predefined communication channel includes an emergency communication channel.

7. The electronic device according to claim 1, further comprising a display, wherein the at least one processor is further configured to display a user interface on the display in response to the signal satisfying the predefined condition.

8. The electronic device according to claim 7, wherein the at least one processor is further configured to identify a region of the display that is exposed when the auxiliary device is deformed, wherein the user interface is displayed in the region.

9. An auxiliary device comprising:
a connection portion coupled to an electronic device; and
a first portion arranged to be deformed when external pressure is applied to the first portion and provide to the electronic device a signal that is generated in response to the first portion being deformed,
wherein the signal is provided to the electronic device via the connection portion.

10. The auxiliary device according to claim 9, further comprising a second portion disposed adjacently to the first portion, wherein:
the first portion is made of a first material, and the second portion is made of a second material that is different from the first material,
the first portion is associated with at least one of a first physical deformation limit value and a first hardness value, and
the second portion is associated with at least one of a second physical deformation limit value that is different from the first physical deformation limit value and a second hardness value that is different from the first hardness value.

11. The auxiliary device according to claim 9, wherein:
the connection portion is electrically connected to the electronic device via a wire-based channel,
the signal includes an electrical signal, and
the signal is provided to the electronic device via the wire-based channel.

12. The auxiliary device according to claim 9, wherein the first portion comprises an element mounted on one side of the first portion that is arranged to generate the signal when the first portion is deformed.

13. The auxiliary device according to claim 9, wherein:
the first portion includes a magnetic element, and
the signal includes a magnetic signal that is provided by the magnetic element.

14. The auxiliary device according to claim 9, wherein the first portion is arranged to be deformed irreversibly.

15. A method for use in an electronic device, comprising:
receiving, by the electronic device, a signal that is generated as a result of a physical deformation of an auxiliary device;
detecting whether the signal satisfies a predefined condition; and
performing, by the electronic device, an operation associated with the predefined condition in response to the signal satisfying the predefined condition.

16. The method according to claim 15, wherein the signal comprises at least one of an electrical signal and a magnetic signal.

17. The method according to claim 15, wherein performing the operation includes at least one of:
initiating an emergency call, and
transmitting information over an emergency communication channel.

18. The method according to claim 15, wherein performing the operation includes displaying a user interface associated with the predefined condition.

19. The method according to claim 18, further comprising identifying a region of the display that is exposed when the auxiliary device is deformed, wherein the user interface is displayed in the region.

20. A method for use in an auxiliary device having a connection portion and a deformable portion, comprising:
generating a signal in response to the deformable portion being deformed by external pressure that is applied to the deformable portion; and
providing the signal to an electronic device via the connection portion.

21. The method according to claim 20, wherein:
the connection portion is electrically connected to the electronic device via a wire-based channel,
the signal includes an electrical signal, and
the signal is provided to the electronic device via the wire-based channel.

22. The method according to claim 20, wherein the deformable portion includes an element that is arranged to provide the signal to the connection portion when the deformable portion is deformed.

23. The method according to claim 20, wherein:
the deformable portion includes a magnetic element, and
the signal includes a magnetic signal that is provided by the magnetic element.

24. A system comprising:
an auxiliary device including a connection portion and a deformable portion configured to be deformed when external pressure is applied to the deformable portion, and provide to the connection portion a signal indicating that the deformable portion is deformed; and
an electronic device coupled to the connection portion of the auxiliary device, wherein the electronic device is configured to receive the signal, detect whether the signal satisfies a predefined condition, and perform an operation associated with the predefined condition in response to the signal satisfying the predefined condition.
